(19) United States
(12) Patent Application Publication
(10) Pub. No.: US 2020/0277813 A1
(43) Pub. Date: Sep. 3, 2020

(54) LOAD PREVENTION FOR DOOR LATCHES

(71) Applicant: Sargent Manufacturing Company, New Haven, CT (US)

(72) Inventors: Timothy Schaeffer, North Haven, CT (US); Darren C. Eller, Madison, CT (US)

(73) Assignee: Sargent Manufacturing Company, New Haven, CT (US)

(21) Appl. No.: 16/779,849

(22) Filed: Feb. 3, 2020

Related U.S. Application Data
(60) Provisional application No. 62/812,144, filed on Feb. 28, 2019.

(51) Int. Cl. E05C 3/30; E05B 65/10

(52) U.S. Cl. CPC E05C 3/30; E05Y 2900/132; E05B 65/10

(57) ABSTRACT

A latching device may include a latch, and a blocker configured to reduce the operational force used to move the latch to a latch disengaged position when an associated door is loaded with a force in a direction of egress. In some embodiments, the blocker may resist the force in the direction of egress by transferring the load the latch in a manner which reduces resultant friction generated by the latch when it is moved to the latch disengaged position. In some embodiments, the blocker may resist the force in the direction of egress by direction the force away from the latch.

### FIELD

Disclosed embodiments are related to a load prevention device for door latches and related methods of use.

### BACKGROUND

Exit devices are typically used to secure doors in high-occupancy structures where operability in crowded conditions is desirable. Multi-point latching devices are commonly used in environments where high security or sever weather resistance is required. For example, many multi-point latches are used in FEMA rated applications such as hurricane and tornado shelters. In some cases, these multi-point latching devices include an exit device, which is configured to actuate the multi-point latching device to allow a door to be opened. Multi-point latching devices may employ vertical rods or cables which are concealed inside of the door or attached to the outside of an interior surface of the door.

### SUMMARY

In some embodiments, a latching device includes a first latch movable between a first latch engaged position and a first latch disengaged position, where in the first latch engaged position the first latch is configured to engage a pocket of an associated door frame, and a blocker configured to move between a blocker engaged position and a blocker disengaged position, where the blocker is configured to engage the pocket when the blocker is in the blocker engaged position. The blocker is configured to resist a force applied to an associated door in a direction of egress.

In some embodiments, a method for operating a latching device includes moving a latch toward an latch engaged position from a latch disengaged position, moving a blocker from a blocker disengaged position to a blocker engaged position, wherein in the blocker engaged position the blocker is partially disposed in a pocket of an associated door frame, moving the latch to the latch engaged position, wherein in the latch engaged position the latch is partially disposed in the pocket, resisting a force applied to an associated door in a direction of egress with the blocker, operating an actuator to move the latch toward the latch disengaged position, and moving the blocker to the blocker disengaged position.

In some embodiments, a latching device includes a hook latch configured to rotate been a latch engaged position and a latch disengaged position, where the hook latch includes an engagement surface configured to engaged an associated strike plate of a door frame, and where the engagement surface is configured to reduce a frictional force between the hook latch the associated strike plate when the hook latch is moved to the latch disengaged position.

It should be appreciated that the foregoing concepts, and additional concepts discussed below, may be arranged in any suitable combination, as the present disclosure is not limited in this respect. Further, other advantages and novel features of the present disclosure will become apparent from the following detailed description of various non-limiting embodiments when considered in conjunction with the accompanying figures.

### BRIEF DESCRIPTION OF DRAWINGS

The accompanying drawings are not intended to be drawn to scale. In the drawings, each identical or nearly identical component that is illustrated in various figures may be represented by a like numeral. For purposes of clarity, not every component may be labeled in every drawing. In the drawings:

FIG. 1 is a perspective view of one embodiment of an exit device including a side latch;

FIG. 2 is a rear elevation view of the exit device of FIG. 1;

FIG. 3 is a front elevation view of the exit device of FIG. 1;

FIG. 4 is a perspective view of one embodiment of an actuator for the exit device of FIG. 1;

FIG. 5 is a right side elevation view of the actuator of FIG. 4;

FIG. 6 is a rear elevation view of the actuator of FIG. 4;

FIG. 7A is an enlarged right side view of section 7A of FIG. 4;

FIG. 7B is an enlarged left side view of section 7B of FIG. 1;

FIG. 8 is a perspective view of one embodiment of a side latch for the exit device of FIG. 1;

FIG. 9 is a perspective view of the side latch of FIG. 8 with a cover removed;

FIG. 10 is another perspective view of the side latch of FIG. 8 with a cover removed;

FIG. 11 is an enlarged elevation view of section 11 of FIG. 10;

FIG. 12 is a perspective view of the side latch of FIG. 9 and one embodiment of a rod guide;

FIG. 13 is a perspective view of one embodiment of a transom latch for the exit device of FIG. 1;

FIG. 14 is another perspective view of the transom latch of FIG. 13;

FIG. 15 is a front elevation view of one embodiment of a door including an exit device according to exemplary embodiments described herein;

FIG. 16 is a side elevation view of the door of FIG. 16;

FIG. 17 is a front elevation view of another embodiment of a door and a door frame;

FIG. 18 is a top schematic of one embodiment of an exit device securing a door;

FIG. 19 is a front schematic of the exit device of FIG. 18;

FIG. 20A is a perspective view of one embodiment of a hook latch and a blocker;

FIG. 20B is a perspective view of the hook latch and blocker of FIG. 20B in a blocker disengaged position;

FIG. 21 is a top schematic of the hook latch and blocker of FIG. 20A in a secure position;

FIG. 22 is a top schematic of the hook latch and blocker of FIG. 20A in an unsecure position;

FIG. 23 is a front schematic of the hook latch and blocker of FIG. 20A in a secure position;

FIG. 24 is a front schematic of the hook latch and blocker of FIG. 20A in an unsecure position;

FIG. 25 is a perspective view of another embodiment of a hook latch and a blocker;

FIG. 26 is a top schematic of the hook latch and blocker of FIG. 25 in a secure position;

FIG. 27 is a top schematic of the hook latch and blocker of FIG. 25 in an unsecure position;

FIG. 28 is a front schematic of the hook latch and blocker of FIG. 25 in a secure position;

FIG. 29 is a front schematic of the hook latch and blocker of FIG. 25 in an unsecure position;

FIG. 30 is a front schematic of another embodiment of a hook latch and a blocker in a secure position;

FIG. 31 is a front schematic of the hook latch and blocker of FIG. 30 in an unsecure position;

FIG. 32 is a front schematic of another embodiment of a hook latch and a blocker in a secure position;

FIG. 33 is a front schematic of the hook latch and blocker of FIG. 32 in an unsecure position;

FIG. 34 is a block diagram of one embodiment for a method of operating a latching device;

FIG. 35 is a top schematic of yet another embodiment of a latch securing a door;

FIG. 36 is a top schematic of yet another embodiment of a latch securing a door;

FIG. 37 is a top schematic of yet another embodiment of a latch securing a door;

FIG. 38 is a top schematic of yet another embodiment of a latch securing a door; and

FIG. 39 is a top schematic of yet another embodiment of a latch securing a door.

### DETAILED DESCRIPTION

In some cases, exit devices employed on a door are tested to standards for operability when high loads are placed on the door in a direction of egress (i.e., in a direction which the door swings open). These types of loading conditions typically invoke high friction between various latches and bolts of the exit device which are in contact with a door frame as the load on the door is increased. These added frictional forces typically increase the force used to operate the exit device which may be undesirable when easy operation of the exit device is desired. In some cases, multi-point latching devices fitted with an exit device have multiple latching points which may induce friction and increase minimum force for operation of the exit device.

In view of the above, the inventors have recognized the benefits of a load blocker which reduces the load on various latches actuated by an exit device when a door is under a high force loading condition. Such an arrangement may reduce the force used to operate an exit device when, for example, multiple people are pressing against the door. The load blocker may reduce the mechanical advantage of the loading on a latch, remove loading on the latch entirely, or otherwise reduce the loading directly applied to the latch. The inventors have also recognized the benefits of a load blocker on hook latches which induce high friction under high loading conditions. Additionally, the inventors have recognized the benefits of employing a load blocker with one or more latches of a multi-point latching device to reduce the force used to operate the multi-point latching device.

In some embodiments, a load blocker for a latching device is configured to rotate between an engaged position in which the load blocker retains the door in a secured state under a high load condition, and a disengaged position in which the load blocker allows the door to open. The load blocker may cooperate with a latch of the latching device to move between the engaged position and disengaged position. For example, the movement of the latch from a latch retracted (i.e., disengaged) position to a latch extended (i.e., engaged) position may move the load blocker from the disengaged position to the engaged position. The load blocker may also be held in the engaged position by the latch, or by a separate mechanical element actuable by the latching device. In either case, the load blocker may direct force received from during a high load condition on the door away from the latch, may reduce the coefficient of friction one the latch, or otherwise reduce the effective resultant frictional force on the latch when the latching device is operated (e.g., via an exit device, handle, etc.). In some embodiments, the load blocker may be configured as a door having a plate hinged at a latch opening formed in the door or latching device (e.g., exit device, mortise lock, etc.). The blocker may pivot about the hinge as the latch is moved between the latch extended position and latch disengaged position so that the blocker stays between the latch and a door strike or jamb which resists motion of the door under high loading conditions (e.g., in a direction of egress). Thus, the load blocker may cooperate with the latch to secure a door under high loading conditions. In some embodiments, the load blocker may be configured to secure the door in a direction of egress (i.e., a direction in which the door swings open) and the latch may be configured to secure the door in a direction of ingress (i.e., a direction in which the door swings closed). Such an arrangement may be desirable in cases where wind based pressure or airborne debris resistance is desirable, as the latching device may retain high security towards external forces via the latch but may still have a low operation force when the door is under high loading conditions, as will be discussed further below.

Traditionally, multi-point latching exit devices are employed in doors to provide additional security or strength. These conventional exit devices employ vertical rods or tethers linked to a central actuator, by which a user can operate multiple latches with the same actuator. The vertical rods may be attached to the exterior of an interior door surface, or may be concealed inside of the door. Typically, these exit devices include a transom latch, a jamb latch, and a threshold latch providing three point fastening for the door which is suitable for environments with high wind and the associated risks of pressure and windborne objects impacting the secured door. Because conventional multi-point exit devices include a threshold latch, space must be made in the floor to accommodate the threshold latch. As many commercial floors are composed of a concrete slab, the installation of conventional threshold latches may be an expensive, time consuming, and laborious process. Additionally, because the threshold latch is formed in the floor, a threshold latch head and corresponding latch head receptacle may collect dirt or grime which may degrade the performance of the exit device over time or inhibit secure locking. In cases where the exit device is at least partially concealed inside of a door, maintenance or repairs of threshold latches with degraded performance may be expensive and time consuming. Additionally, installation or removal of threshold latches concealed in the door typically require removal of the door panel which is time consuming and labor intensive.

In view of the above, the inventors have recognized the benefits of a multi-point locking or latching device which includes a transom latch coupled to a first rod and a side latch coupled to a second rod which in combination secure a door. The side latch may include a hook latch head configured to positively grasp the door jamb when engaged. Such an arrangement may be beneficial to withstand high wind pressure loads and windborne objects in accordance with modern safety standards. The side latch may be easily installed or removed via a mortise opening in the door without removal of a door panel. The inventors have also recognized the benefits of an actuator including two cams which apply force to the first and second rods concurrently when a lever is rotated to promote reliable activation of the transom latch and side latch. In some embodiments, the side latch may be combined with a load blocker to improve resilience to wind or airborne debris while reducing the operational force of the latching device under high loading.

In some embodiments, an exit device includes an actuator, a transom latch, a side latch, and a load blocker. The actuator may be operatively coupled to the transom latch and the side latch so that the transom latch and side latch may be operated concurrently by a single actuation of the actuator. Additionally, the load blocker may cooperate with the side latch to be operated concurrently with the side latch. In some embodiments, the actuator may be connected to the transom latch by a first (i.e., upper) rod and the side latch connected to the side latch by a second (i.e., lower) rod, such that when the actuator is actuated by a user, the first rod and second rod may be moved linearly along their respective axes to operate the transom latch and side latch. When the side latch is in the engaged position (i.e., extended position), the load blocker may be disposed between the side latch and a portion of a door strike or door jamb which resists the opening of the door when the door is under high loading conditions. The load blocker may inhibit contact between the side latch and the portion of the door strike or door jamb which resists the opening of the door so that high loading on the side latch may be reduced or otherwise controlled to keep an the force of operation of the exit device low.

Turning to the figures, specific non-limiting embodiments are described in further detail. It should be understood that the various systems, components, features, and methods described relative to these embodiments may be used either individually and/or in any desired combination as the disclosure is not limited to only the specific embodiments described herein.

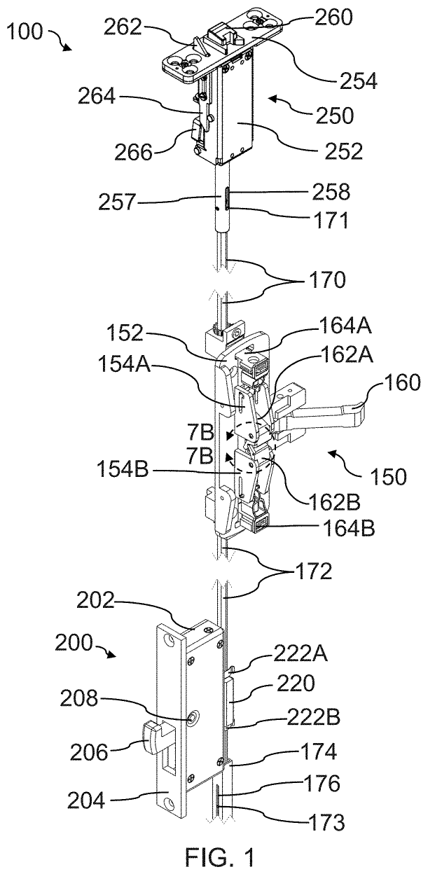

FIG. 1 is a perspective view of one embodiment of an exit device 100 (e.g., a latching device) including an actuator 150, a side latch 200, and a transom latch 250. As shown in FIG. 1, a first rod 170 operatively couples the actuator to the transom latch 250 and a second rod 172 operatively couples the actuator to the side latch 200. According to the depicted embodiment, the exit device is configured to be mounted inside of the door (not shown in FIG. 1), so that a majority of the components are substantially concealed from view. Of course, the exit device may visible or partially concealed, as the present disclosure is not so limited. As shown in FIG. 1, the exit device is arranged with the first and second rods in a vertical orientation, with the transom latch configured to engage a door transom and the side latch configured to engage a door jamb. As the transom latch and side latch are both linked to the same centralized actuator, the transom latch and side latch may be actuated concurrently to selectively secure or release a door.

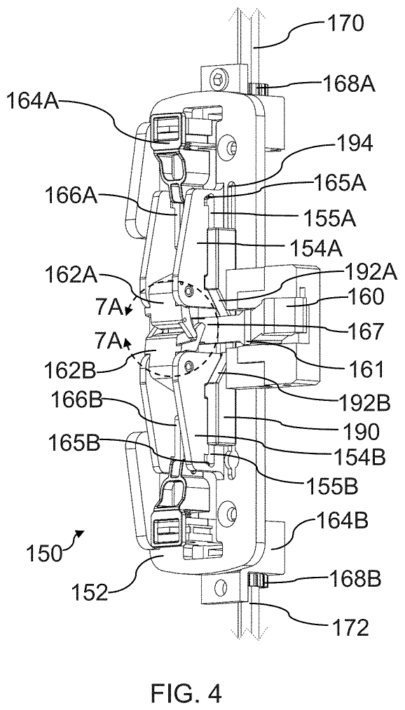

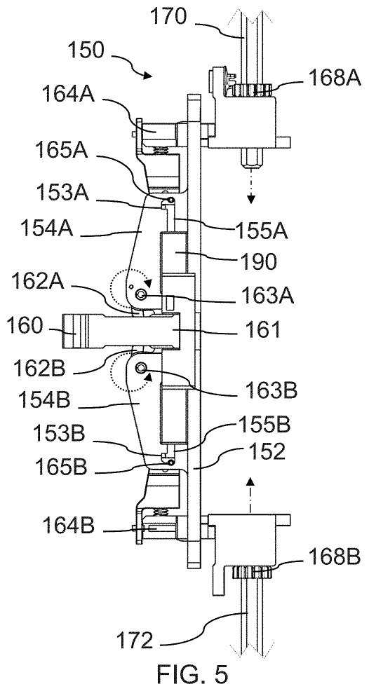

According to the embodiment shown in FIG. 1, the actuator 150 includes a chassis 152, a lever 160, a first cam 162A coupled to a first rod holder 164A, and a second cam 162B coupled to a second rod holder 164B. The lever is rotatably mounded to the chassis 152 and is configured to rotate about an axis which is parallel with a longitudinal axis of the first rod 170 and second rod 172. The first cam and second cam are also rotatably mounted to the chassis and are held by first guide wall 154A and second guide wall 154B, respectively, such that both of the cams rotate about an axis substantially orthogonal to the rotational axis of the lever. The first rod holder 164A is configured to secure the first rod 170 to the actuator, and is slidably mounted to the chassis so that the first rod may be moved along its longitudinal axis (i.e., a first axis). Likewise, the second rod holder 164B is configured to secure the second rod 172 to the actuator and is slidably mounted to the chassis to allow the second rod to be moved along its longitudinal axis (i.e., a second axis). The first rod holder is coupled to an end of the first cam so that rotational motion of the first cam causes linear motion of the first rod holder along the first axis. The second rod holder is coupled to an end of the second cam so that rotational motion of the second cam causes linear motion of the second rod holder along the second axis. As will be discussed further with reference to FIGS. 4-5, when the lever is rotated (i.e., actuated), the lever engages at least one of the first cam and the second cam to rotate the first and second cams in opposite directions. As the first and second cams are coupled to the first and second rod holders, respectively, the first rod holder is moved in a first direction along the first axis and the second rod holder is moved in a second direction along the second axis as the cams are rotated. According to the embodiment shown in FIG. 1, the first direction and second direction may be opposite one another such that the first rod holder and second rod holder are moved closer to one another when the lever is actuated (e.g., rotated).

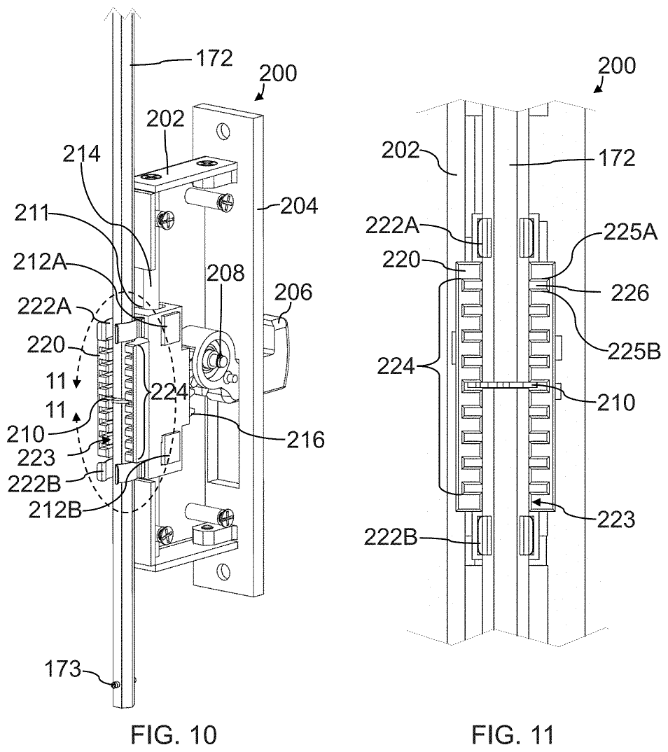

As shown in FIG. 1, the side latch 200 includes a chassis 202, a face plate 204 and a hook latch head 206. The chassis is configured to fit into a mortise opening formed in a door, and may be secured to the door by the face plate. The hook latch head is rotatably mounted to the chassis via hook latch head pin 208. As shown in FIG. 1, the side latch is coupled to the second rod 172 by a rod coupler 220 which fits around the second rod. Spring clips 222A, 22B, releasably secure the second rod inside the rod coupler. As will be discussed further with reference to FIGS. 10-11, the rod coupler transmits longitudinal motion of the second rod into rotational motion of the hook latch head, so that movement of the second rod along the second axis may move the hook latch head between an engaged position and a disengaged position. In the state shown in FIG. 1 the hook latch head is in an engaged position, projecting past the face plate 204 so that the hook latch head would engage an associated door jamb when adjacent a hook latch head receptacle. According to the embodiment of FIG. 1, the second rod 172 is disposed partially in a rod guide 174. The second rod guide includes a rod guide slot 176 which receives a second rod pin 173 disposed on the second rod. The second rod guide substantially constrains the second rod to linear movement along the second axis (i.e., the longitudinal axis of the second rod).

According to the embodiment of FIG. 1, the side latch may be disposed below a centerline of a door such that the door may be secured at different portions of the door (e.g., top and bottom portions). Without wishing to be bound by theory, the distance of the side latch head from the top of the door may at least partially determine the amount of deflection of a door place under pressure or impact loads. Accordingly, in some embodiments, the hook latch head of a side latch may positioned below a top of a door by a distance greater than ½ of the door length, ⅝ of the door length, ⅔ of the door length, ¾ of the door length, or any other appropriate distance. Correspondingly, the hook latch head may be positioned below a top of a door by a distance of less than ⅝ of the door length, ⅔ of the door length, ¾ of the door length, the door length, of any other appropriate distance. Combinations of the above noted ranges are contemplated, as the present disclosure is not so limited.

As shown in FIG. 1, the transom latch 250 includes a chassis 252, a face plate 254, a latch head 260, and a trigger 262. The latch head 260 may be directly coupled to the first rod 170 so that movement of the first rod along the first axis (i.e., a longitudinal axis of the first rod) moves the latch head between an engaged and disengaged position. According to the depicted embodiment, the latch head 260 does not include a substantially inclined face, and will therefore not automatically retract when the latch head contacts a transom strike plate. In order to prevent interference or premature engagement of the latch head with a transom strike plate, the transom latch includes a lockout 266 which is controlled by the trigger 262. According to the embodiment of FIG. 1, the lockout is configured to allow movement of the latch head toward a disengaged position (i.e., where the latch head is substantially retracted to clear a transom strike plate without interference). However, the lockout is configured to prevent movement of the latch head toward an engaged position (i.e., where the latch head is substantially extended to engage a transom strike plate). Accordingly, when the transom latch head is retracted the lockout will retain the transom latch head in the disengaged position so that the transom latch head does not interfere with door opening or closing. The trigger 262 is configured to move between an extended position and a retracted position and includes an inclined face which is suitable to automatically retract the trigger when the trigger contacts a transom strike plate. As shown in FIG. 1, the trigger is configured to engage the lockout when the trigger is moved to the retracted position with a lockout engagement portion 264 configured as a camming surface. When the trigger engages the lockout (e.g., along a camming surface) the lockout may release the transom latch head 260 so that the latch head may move to the engaged position to secure the door once the door is closed. Thus, the latch head and trigger arrangement shown in FIG. 1 may allow for automatic latching of the transom latch head without inclusion of an inclined face on the transom latch head. According to the embodiment shown in FIG. 1, the chassis 252 is coupled to a transom rod guide 257 which includes a transom rod guide slot 258 with receives a first rod pin 171 disposed on the first rod to substantially constrain the movement of the first rod to linear movement along the first axis (i.e., the longitudinal axis of the first rod).

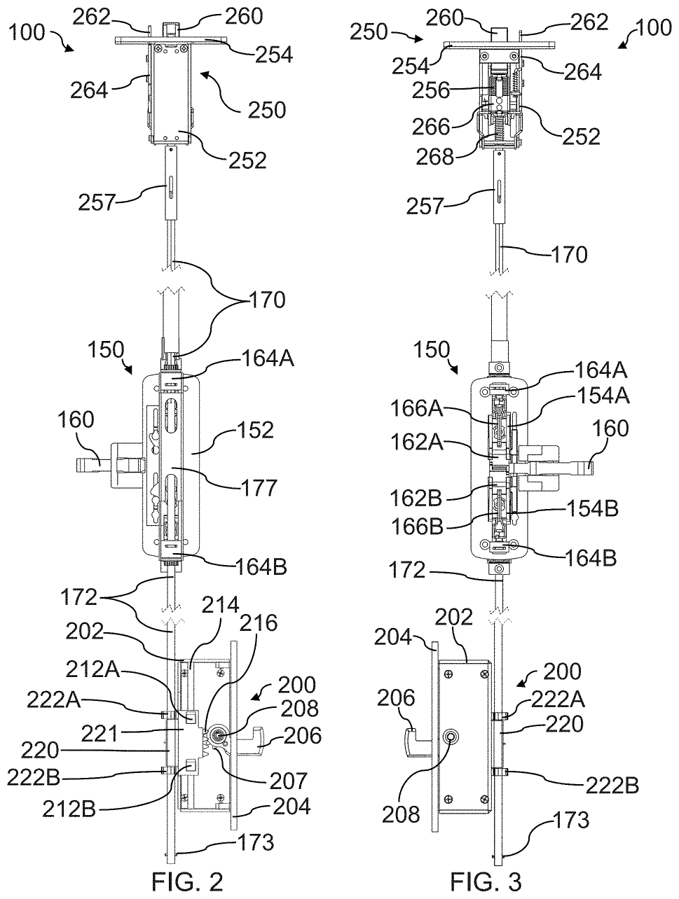

FIG. 2 is a rear elevation view of the exit device 100 of FIG. 1. As shown in FIG. 2, the rear panel of the side latch 200 has been removed to show the internal components of the side latch. As discussed previously, the side latch includes a hook latch head 206 rotatably coupled to a chassis by a hook latch head pin 208 and a rod coupler 220 operatively coupled to the second rod 172 so that linear movement of the second rod is converted into rotational motion of the hook latch head. As shown in FIG. 2, the hook latch head includes a plurality of gear teeth 207 disposed in an arc in a circumferential arrangement around the hook latch head pin 208. Correspondingly, the rod coupler includes a slide body 221 which includes a plurality of gear teeth 216 configured to mesh with the teeth of the hook latch head. As shown in FIG. 2, the slide body 221 is disposed around guide rail 214 so that the slide body is constrained to move in a linear direction along the guide rail parallel to the longitudinal axis of the second rod. Accordingly, the rod coupler forms a rack and the hook latch head forms a pinion so that linear movement of the second rod is converted into rotational movement of the hook latch head which may be used to move the hook latch head between the hook engaged and hook disengaged positions.

As shown in FIG. 2, the actuator 150 also includes a rear actuator rod guide 177 which is configured to substantially constrain the first rod 170 and first rod holder 164A as well as the second rod 172 and second rod holder 164B to linear movement along the first axis of the first rod and second axis of the second rod, respectively. Accordingly, the actuator may use camming motions to precisely and reliably move the first and second rods along their longitudinal axis to actuate the transom latch and side latch.

FIG. 3 is a front elevation view of the exit device 100 of FIG. 1. As discussed previously, the actuator 150 includes a lever 160, a first cam 162A, a second cam 162B which cooperate to move the first rod 170 and second rod 172 along the first axis and second axis, respectively. As shown in FIG. 3, the first cam is coupled to the first rod holder 164A by a first linkage 166A and the second cam is coupled to the second rod holder by a second linkage 166B. The first and second cam linkages are rotatably linked (e.g., by a linkage pin) to both their respective cams and rod holders so that the rotational motion of the cams may be converted into linear motion of the rod holders.

As discussed previously, the transom latch includes a trigger 262 and a lockout 266 which cooperate to allow the latch head 260 to automatically extend into a transom strike plate without interference when the door is being opened or closed. As shown in FIG. 3, the lockout 266 interfaces with a plurality of ratchet teeth 256 so that the latch head 260 is progressively retained at it is moved to the disengaged (i.e., retracted) position. When the trigger 262 is moved from the extended position shown in FIG. 3 to the retracted position, the lockout engagement portion 264 cams the lockout out of engagement with the ratchet teeth so that the latch head 260 may move to toward the engaged position. Of course, while ratchet teeth are employed in the depicted embodiment, any suitable progressive or non-progressive retaining element may be employed, as the present disclosure is not so limited. As shown in FIG. 3, the transom latch includes a biasing member configured as a compression spring which urges the latch head toward the engaged position. Accordingly, when released by the trigger, the latch head may automatically move to the engaged position under influence of the compression spring. Of course, while a compression spring is employed in the embodiment of FIG. 3, any suitable biasing member may be employed as the present disclosure is not so limited.

According to the embodiment shown in FIG. 3, the biasing member 268 may apply an urging force to the first rod 170 so that the first rod is urged to a position which corresponds to the transom latch head 260 being in an engaged position. As the urging force is transmitted through the first rod to the actuator and from the actuator to the side latch through the second rod, the hook latch head 206 may also be urged toward a hook engaged position. Thus, the linkage of the first rod and second rod through the actuator may allow a single biasing member to be employed in any one of the transom latch, actuator, and side latch. Such an arrangement may be beneficial to simplify installation and reduce parts and cost.

FIG. 4 is a perspective view of one embodiment of an actuator 150 for the exit device of FIG. 1. As discussed previously, the actuator is configured to allow a first rod 170 and a second rod 172 to move concurrently along a first axis (corresponding to a longitudinal axis of the first rod) and a second axis (corresponding to a longitudinal axis of the second rod), respectively. As best shown in FIG. 4, the lever 160 is rotatably mounted to the chassis by a hinge portion 161. A cam engagement portion 167 of the lever engages both the first cam 162A and the second cam 162B. The first cam and second cam are rotatably mounted to a first guide wall 154A and a second guide wall 154B, respectively. Accordingly, when the lever is rotated about the hinge portion, the cam engagement portion 167 will engage both the first cam and second cam to rotate the cams in opposite directions about parallel axes. The first cam is coupled to a first rod holder 164A by a first linkage 166A which converts the rotational motion of the cam to linear motion of the first rod holder. The first rod holder and first linkage are at least partially disposed in a first linkage slot 155A formed in the first guide wall 154A which at least partially constrains to the first linkage and first rod holder to linear movement. Similarly, the second cam is coupled to a second rod holder 164B by a second linkage 166B which is disposed at least partially in second linkage slot 155B formed in the second guide wall. According to the embodiment shown in FIG. 4, when the lever is rotated about the hinge portion 161, the cams draw the first rod holder and second rod holder closer together, thereby applying tension through the rods to a transom latch and/or side latch. Of course, in other embodiments, the cams may rotated to move the first rod holder and second rod holder further apart to apply compression through the rods, as the present disclosure is not so limited. As shown in FIG. 4, the relative position of the first and second rods to the first and second rod holder may be adjusted by rotating a first adjustment nut 168A or a second adjustment nut 168B, respectively.

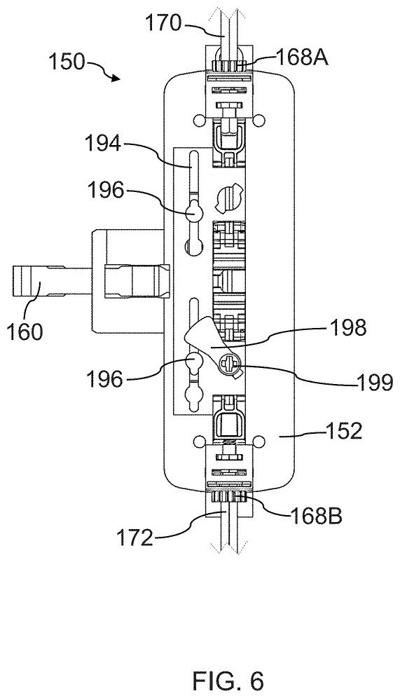

As shown in FIG. 4, the actuator also includes a slider 190 disposed in a slider slot 194 formed in the chassis 152 of the actuator. The slider includes a first inclined camming surface 192A and a second inclined camming surface 192B which are configured to selectively engage the lever 160 to rotate the lever. As will be discussed further with reference to FIG. 6, the slider 190 may be operatively coupled to an interior handle or other actuator so that the lever may be actuated from a side of the door from which the lever is not accessible. When the slider engages the lever, the lever may be cammed to correspondingly rotate the first and second cams 162A, 162B to actuate an associated lock with the first rod 170 and second rod 172. According to the embodiment of FIG. 4, the lever may be operatively connected to a user interfacing element such as a paddle, push bar, or other suitable arrangement so that a user may easily actuate the lever.

FIG. 5 is a right side elevation view of the actuator 150 of FIG. 4. As best shown in FIG. 5, the first rod 170 and the second rod 172 are moveable along their longitudinal axes by movement of the first rod holder 164A and second rod holder 164B, respectively. The first rod holder is constrained at least partially to linear movement by first linkage pin 165A which is disposed in the first linkage slot 155A and couples the first rod holder to the first linkage (see FIG. 4). Likewise, the second rod holder is constrained at least partially to linear movement by second linkage pin 165B which is disposed in second linkage slot 155B and couples the second rod holder to the second linkage (see FIG. 4). According to the embodiment shown in FIG. 5, the first and second rods have coincident axes (i.e., the longitudinal axes of both rods are coincident). Accordingly, when the lever 160 is actuated the first and second rods are moved toward or apart from one another along the same coincident axis. As shown in FIG. 5, the first cam 162A is rotatably coupled to the first guide wall 154A by first cam pin 163A and the second cam 162B is rotatably coupled to the second guide wall 154B by a second cam pin 163B. In the depicted embodiment, the first cam and second cam are configured to rotate equally in opposite directions about their respective axes when engaged by the lever 160. As shown by the dashed arrows, in this embodiment, the first cam rotates clockwise relative to the page to move the first rod holder in a first direction (see dot-dash arrow) while the second cam rotates in a counterclockwise direction relative to the page to move the second rod holder in a second direction (see long-dot-dash arrow, where the first direction and the second direction are opposite one another and move the first and second rod holders closer together). Correspondingly, when the cams rotate in opposite directions the first and second rods will move further apart along their coincident axes. According to the embodiment of FIG. 5, rotation of the lever by a user may move the first and second rods closer together along their coincident axes, applying tension through the rods to move any associated lock to a disengaged position.

According to the embodiment shown in FIG. 5, the actuator includes first and second deadlatching catches 153A, 153B formed as a part of the first linkage slot 155A and second linkage slot 155B. The deadlatching catches are configured to prevent movement of the first rod holder 164A or second rod holder 164B without direct actuation of the lever 160. That is, force applied directly to the first or second rods may cause the first linkage pin 165A and second linkage pin 165B to engage and abut against first deadlatching catch 153A and second deadlatching catch 153B, respectively. Thus, force which is externally applied to the exit device (e.g., to a transom latch head or a hook latch head) may not move the rods to release the door. If the actuator is properly actuated, rotation of the first cam 162A and the second cam 162B may draw the first pin and second pin out of the deadlatching catches and into the first linkage slot 155A and second linkage slot 155B. The direction of rotation of the first cam and the second cam may be suitable to draw the pin out of the deadlatching catch to allow the first rod holder and second rod holder to move toward one another to release the door upon direct actuation of the lever 160.

FIG. 6 is a rear elevation view of the actuator 150 of FIG. 4. As best shown in FIG. 6, the actuator includes a handle mount 199 including a wing 198 configured to engage one of two tabs 196 of a slider (see FIG. 4). The tabs are disposed in slider slot 194. When an attached handle is turned, the wing 198 may engage one of the tabs 196 to slide the slider in the slider slot 194. As discussed previously, this movement may cause an inclined camming surface of the slider to engage the lever 160 to actuate the exit device (e.g., by moving the first rod holder and second rod holder toward one another). Of course, while a handle attachment and wing are shown in FIG. 6, any suitable arrangement may be employed to allow the exit device to be actuated from a side of the door where the lever is not accessible.

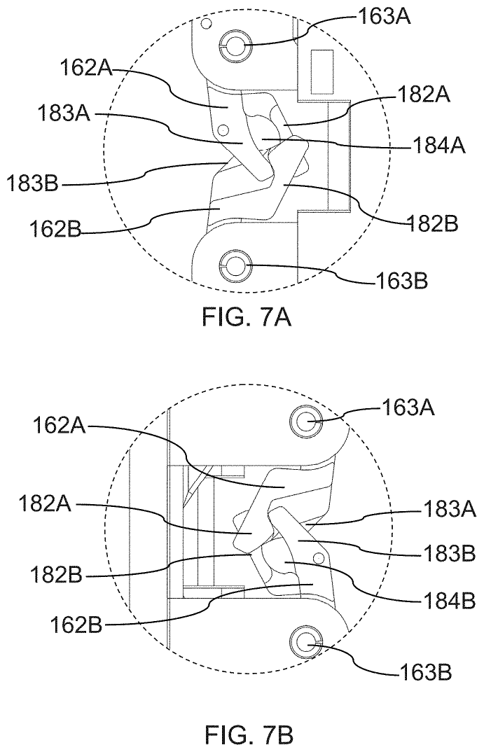

FIG. 7A is an enlarged right side view of section 7A of FIG. 4 and FIG. 7B is an enlarged left side view of section 7B of FIG. 1 depicting first cam 162A and second cam 162B with the lever removed for clarity. As shown in FIG. 7A, the first cam includes a first cam lobe 184A, a first upper arm 183A, and a first lower arm 182A. Similarly, as shown in FIG. 7B, the second cam includes a second cam lobe 184B, a second upper arm 183B, and a second lower arm 182B. As shown in FIG. 7A, the first upper arm engages the second lower arm. As shown in FIG. 7B, the second upper arm engages the first lower arm. Accordingly, the first and second cams are intermeshed and will rotate together about the first cam pin 163A and second cam pin 163B, respectively. That is, even in the case of misalignment of the lever so that the lever only engages one of the cam lobes, the cams will rotate concurrently so that the coupled rod holders will also move concurrently. Additionally, forces transmitted from one rod holder another rod holder may be transmitted through the intermeshed cams without interference or input of the lever. Thus, the intermeshed cam may provide reliable concurrent actuation of the exit device.

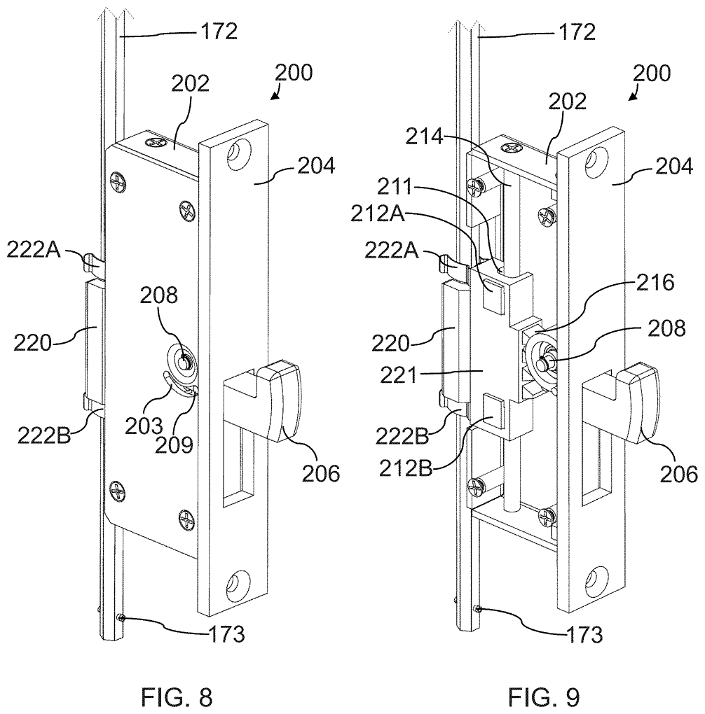

FIG. 8 is a perspective view of one embodiment of a side latch 200 for the exit device of FIG. 1. As discussed previously, the side latch includes a hook latch head 206 which is configured to rotate between a hook engaged position and a hook disengaged position. The hook latch head is rotatably mounted to the chassis 202 via a hook latch head pin 208. Additionally, as shown in FIG. 8, the chassis includes a hook latch head slot 203 which receives a hook latch head guide 209. In addition to guiding the hook latch head through rotational motion, the hook latch head slot 203 may also be used to set predetermined limits on the range of rotation of the hook latch head. That is, the hook latch head slot may determine the range of motion of the hook latch head so that the hook latch head may be reliably moved between the hook engaged and hook disengaged position to secure a door.

FIG. 9 is a cutaway perspective view of the side latch 200 of FIG. 8 with a portion of the chassis 202 removed to show the internal components of the side latch. As discussed previously, the side latch includes a rod coupler 220 and a hook latch head 206. The rod coupler includes a slide body 221 which receives linear motion of second rod 172 and converts it into rotary motion of the hook latch head via gear teeth 216. As best shown in FIG. 9, the slide body 221 is slidably coupled to the chassis 202 via a guide rail 214 disposed in a guide channel 211 formed in the slide body. The guide rail is secured in the guide channel 211 with a first clip 212A and a second clip 212B which secure the slide body to the guide rail but allow the slide body to move with second rod 172 to move the hook latch head between the hook engaged position and the hook disengaged position.

FIG. 10 is another cutaway perspective view of the side latch 200 of FIG. 8 showing the interface between the rod coupler 220 and the second rod 172. As shown in FIG. 10, the rod coupler includes a channel 223 which is formed to accommodate the second rod. The rod coupler also includes a first spring clip 222A and a second spring clip 222B which releasably secure the second rod 172 in the channel. The rod coupler also includes a plurality of grooves 224 which are formed in a transverse direction across the channel 223. The grooves are each configured to receive a retaining ring 210 which is attached to the second rod. The retaining ring may be releasably secured to an annular groove in the second rod so that the retaining ring may be used to transmit longitudinal force from the second rod. When the retaining ring is disposed in one of the grooves, force may be transmitted from the second rod to the rod coupler and vice versa via the interface between the groove and retaining ring. The spring clips 222A, 222B keep the retaining ring secure in the groove. Without wishing to be bound by theory, providing a plurality of grooves may allow for simplified installation of the side latch into a door. As will be discussed further with reference to FIG. 11, rather than adjusting the position of the retaining ring or second rod which may be concealed in a door, the side latch may be pushed into a mortise opening and the retaining ring will align with and engage the nearest groove of the plurality of grooves 224. Thus, minimal adjustment of the rod or the side latch may be necessary to install the side latch.

FIG. 11 is an enlarged elevation view of section 11 of FIG. 10 showing the plurality of grooves 224 and retaining ring 210 in detail. As discussed previously, the second rod 172 is disposed in the rod coupler channel 223 and secured therein by spring clips 222A, 222B. Of course, while multiple spring clips are shown in FIGS. 10-11, any number of suitable retaining elements may be employed, as the present disclosure is not so limited. As best shown in FIG. 11, each of the plurality of grooves includes a first inclined lead-in 225A, and second inclined lead-in 225B, and a retaining groove 226. The inclined lead-ins may be suitable to guide the retaining ring into the nearest groove when the side latch is inserted into a mortise opening. That is, the lead-ins allow the second rod and retaining ring 210 to self-align with the nearest groove based on the camming action of the inclined lead-ins. Once disposed in the retaining groove 226, the retaining ring may transmit force between the rod coupler 220 and the second rod so that the hook latch head (see FIGS. 8-9) may be moved between a hook engaged and a hook disengaged position. According to the embodiment shown in FIGS. 10-11, the rod coupler includes nine grooves which provide a suitable amount of self-adjustability between the side latch and the second rod. However, any suitable number of grooves may be employed to provide any suitable amount of adjustability, including, but not limited to, as few as two grooves and as many as 20 grooves.

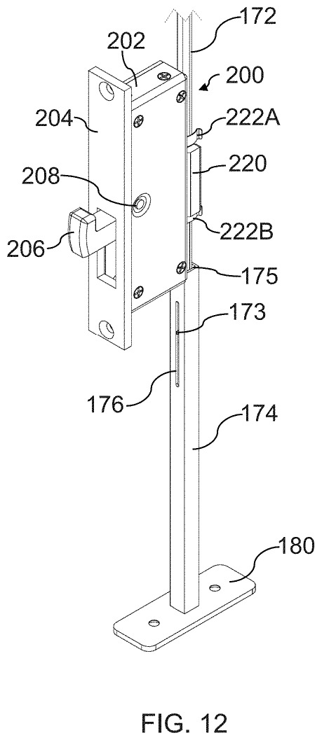

FIG. 12 is a perspective view of the side latch 200 of FIG. 9 and one embodiment of a rod guide 174. As shown in FIG. 12, the rod guide includes a rod channel 175, and rod guide slot 176, and a base 180. The base is configured to be mounted to the threshold portion of a door to secure the rod guide to the door. The rod channel 175 receives the second rod 172 and may be shaped and sized to limit the range of motions for the second rod. That is, the second rod may be closely fit or have a complementary shape with the rod channel so that the second rod is substantially constrained to linear motion along its longitudinal axis and alignment between the second rod and side latch is maintained. Additionally, the rod guide slot 176 is configured to receive a second rod pin 173 so that the motion of the second rod is further limited to motion along its longitudinal axis. Such an arrangement may promote reliable and consistent actuation of the side latch. Additionally, as shown in FIG. 12, the rod guide may extend from the bottom the door past to a position proximate the chassis 202 of the side latch. That is, the rod guide may be approximately equidistant from the bottom of a door relative to the bottom of the chassis of the side latch. Such an arrangement may provide substantial stability to the second rod without interference with the installation or operation of the side latch. Of course, the rod guide may have any suitable shape or extend any suitable distance from the bottom of the door to effectively guide the second rod, as the present disclosure is not so limited.

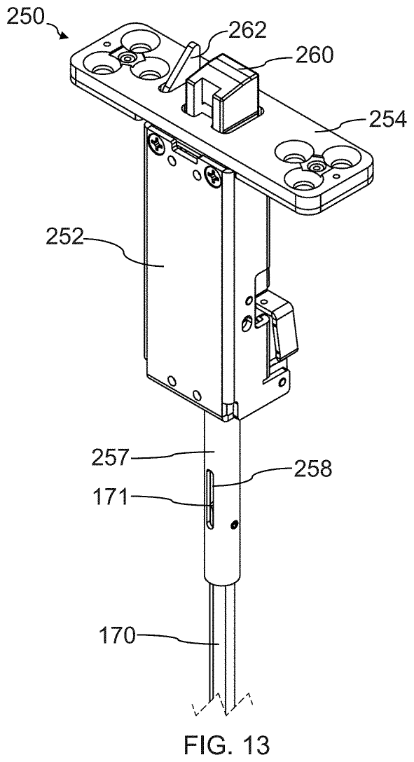

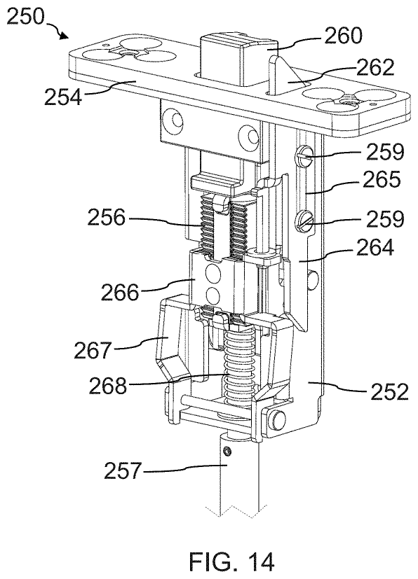

FIG. 13 is a perspective view of one embodiment of a transom latch 250 for use in the exit device of FIG. 1. As discussed previously, the transom latch is configured to secure an associated door to a door frame transom. The transom latch includes a chassis 252 which is secured in the top of the door by transom face plate 254. The transom latch includes a latch head 260 and a trigger 262. The trigger 262 has an inclined face and is configured to automatically retract when the trigger strikes a transom strike plate, whereas the latch head 260 is not configured to automatically retract. Accordingly, the trigger may be employed to time the release of the latch head 260 so that the latch head does not interfere with a transom strike plate when opening or closing the door, as will be discussed further with reference to FIG. 14. As shown in FIG. 13, the chassis 252 of the transom latch includes a transom rod guide 257 which is configured to receive the first rod 170. The first rod guide includes a transom rod guide slot 258 configured to receive a first rod pin 171 which constrains the motion of the first rod to linear motion along its longitudinal axis and maintains alignment of the first rod with the transom latch. Accordingly, the first rod 170 may be used to reliably move the latch head 260 between engaged and disengaged positions with linear motion.

FIG. 14 is another perspective view of the transom latch 250 of FIG. 14 showing the lockout 266 and trigger 262 in detail. As best shown in FIG. 14, the trigger 262 is configured to slide on trigger supports 259 disposed in trigger slot 265. The trigger includes a lockout engagement portion 264 which is configured as a camming surface which moves the lockout when the trigger is moved from the extended position shown in FIG. 14 to a retracted position. The lockout 266 is disposed on a rotatable lockout arm 267 and is configured to engage a plurality of ratchet teeth 256. The lockout may be spring loaded so that the lockout positively engages the ratchet teeth in a resting position. The ratchet teeth are configured to allow the latch head 260 to move from the engaged position (e.g., extended position) shown in FIG. 14 to a disengaged position (e.g., a retracted position) but does not allow the opposite motion. Accordingly, when the latch head is retracted by activation of an associated actuator and tension applied through a first rod, the lockout progressively engages the ratchet teeth to maintain the latch head in the disengaged position. When the associated actuator is released (e.g., when the door is fully open), the latch head is kept in the disengaged position by the lockout against the urging of a biasing member 268 which urges the latch head toward the engaged position. When the door closes and the trigger is retraced by a transom strike plate, the lockout engagement portion (i.e., a first camming surface) engages the rotatable lockout arm (i.e., a second camming surface) to move the lockout up and away from the ratchet teeth. When the lockout clears the ratchet teeth, the latch head may automatically return to the engaged position under influence from the biasing member 268. The trigger 262 may be configured so that the lockout does not clear the ratchet teeth to release the latch head until the latch head is positioned over a transom latch head receptacle so that interference during extension is minimized or eliminated.

According to the embodiment shown in FIG. 14 and as discussed previously, the biasing member 268 may be used to bias the entirety of the exit device mechanism toward a secure position (i.e., where all associated latches are in engaged positions). Accordingly, the lockout 266 may also be used to control the motion of the entirely of the exit device, and, in particular, an associated side latch having a hook latch head (see FIGS. 8-9). That is, when the exit device is actuated and the latch head is moved to a disengaged position, a hook latch head of the side latch may also be moved to a hook disengaged position. When the lockout engages the ratchet teeth 256, it may hold both the latch head 260 and the hook latch head in the disengaged positions so that there is no interference opening and closing the door. When the trigger causes the lockout to clear the ratchet teeth, the latch head and the hook latch head may be released so that they may be moved to the engaged and hook engaged positions, respectively. The trigger may be configured to release the latch head and hook latch head once each of the latch heads is positioned over a corresponding receptacle so that interference between the latch heads and the door frame is reduced or eliminated.

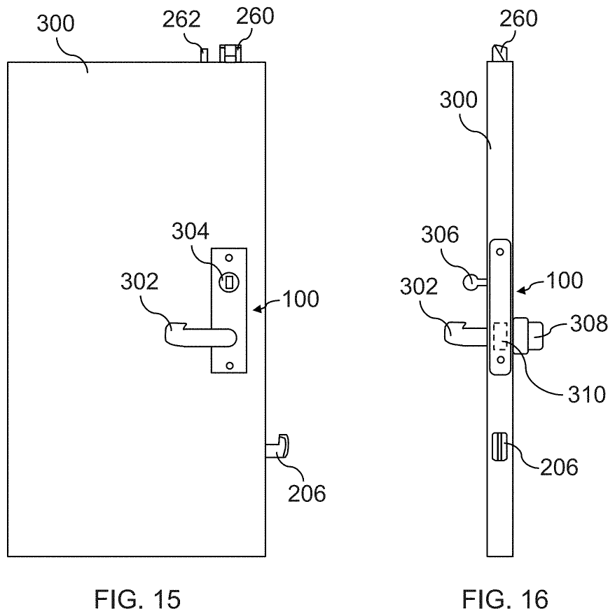

FIG. 15 is a front elevation view of one embodiment of a door 400 including and exit device 100 according to exemplary embodiments described herein. As shown in FIG. 15, the door includes an exit device 100 having a transom latch head 260, a trigger 2662, and a hook latch head 206 which projects from a side of the door. According to the state shown in FIG. 15, the exit device is in the secured position with the transom latch head 260 in an engaged position and the hook latch head 206 in a hook engaged position which would secure the door to an associated door frame transom and door jamb, respectively. As discussed previously, the trigger 262 may be configured to allow the transom latch head and the hook latch head to extend automatically when the door is closes without significant interference with the door frame. As shown in FIG. 15, the door also includes a handle 402 and a keyhole 404. The handle may be coupled to a handle attachment of an actuator of the exit device, so that the handle may be turned to move the transom latch head and hook latch head toward a disengaged position and hook disengaged position, respectively. The keyhole may be operated with the use of a corresponding key which may be used to selectively allow use of the handle (i.e., lock or unlock the handle of the door). Of course, any suitable locking device and user interface for interacting with the exit device may be employed in a door, as the present disclosure is not so limited.

FIG. 16 is a side elevation view of the door 400 of FIG. 15. As shown in FIG. 16, the side of the door opposite that of the handle 402 includes a push bar 408 which may be used to actuate a lever of the exit device 100. That is, a user may push on the push bar 408 to rotate the lever to move the hook latch head 206 and transom latch head 260 toward a disengaged position and hook disengaged position, respectively, to release the door. In some embodiments, the push bar may be positioned on an interior side of the door which swings outward for efficient egress of an interior space. Of course, while a push bar is shown in FIG. 16, any suitable user interface device which allows a user to actuate the exit device may be employed, as the present disclosure is not so limited. According to the embodiment shown in FIG. 16 and discussed previously, a key 406 may be used to selectively allow actuation of the exit device with the handle 402. Such an arrangement may be beneficial to lock an exterior side of the door on which the handle may be disposed. In some embodiments, the exit device may include an optional third latch head 410 disposed near the handle 402 and push bar 408 which is moved between an engaged position and disengaged position in conjunction with the transom latch head 260 and hook latch head 206. Of course, any suitable number of latch heads or bolts may be employed in the exit device to secure the door to an associated door frame, as the present disclosure is not so limited.

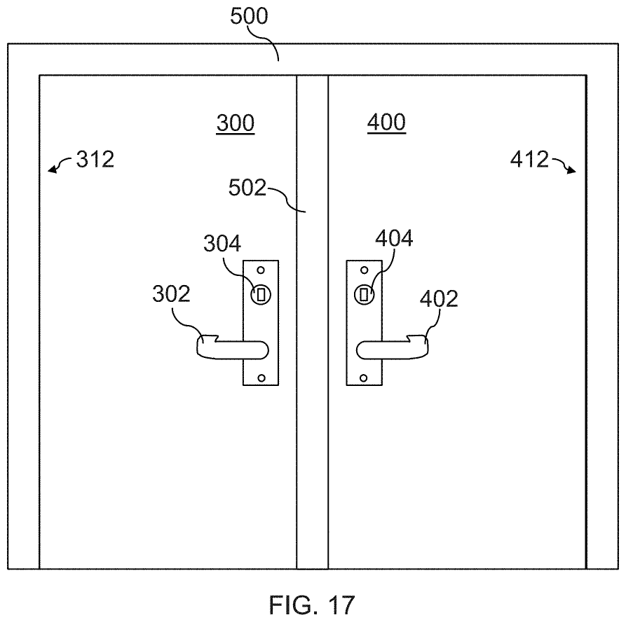

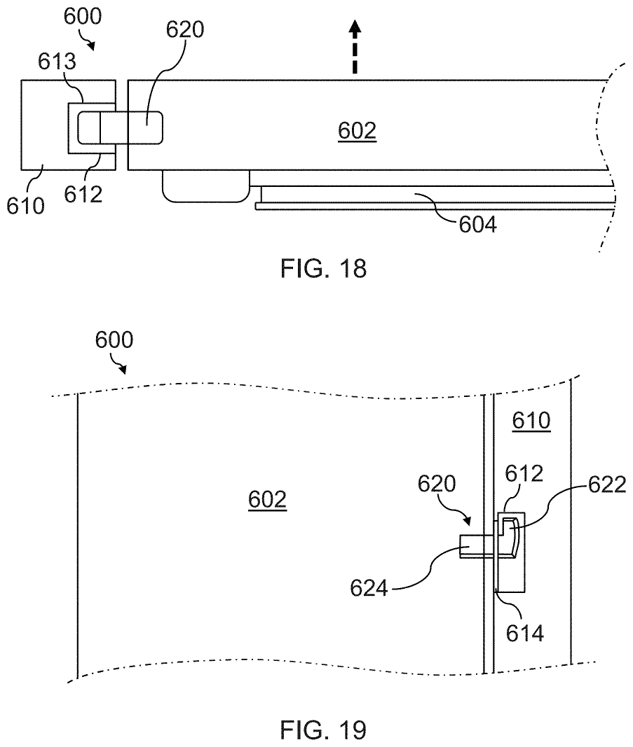

FIG. 17 depicts one embodiment of a door including a first door panel 400, a second door panel 500, and a door frame 600 having a mullion 602. The first door panel is mounted to the door frame at a first hinge interface 412 and the second door panel is mounted to the door frame at a second hinge interface 512. As shown in FIG. 18, a first handle 402 is mounted to the first door panel and is configured to operate an exit device attached to the door. The exit device may include a transom latch and a side latch, similar to the embodiment shown in FIGS. 15-16. Additionally a keyhole 404 may be used to selectively secure the first handle 402. According to the embodiment of FIG. 17, the exit device attached to the first door panel includes a side latch which engages the mullion 602. The mullion may be secured to the door frame transom and an underlying floor so that the secured door may withstand impacts or other forces. According to the embodiment shown in FIG. 17, the second door panel also accommodates an attached exit device which is operable with a second handle 502. Additionally, a second keyhole may be used in conjunction with a key to selectively secure the second handle. The exit device attached to the second door panel may be similar to that attached to the first door panel. In some embodiments, an exit device attached to the second door panel may not include a central actuator, and may instead include a transom bolt, mullion bolt, or bottom bolt which may be manually moved to secure the door. Of course, the second door panel may have any suitable exit device, latch head, bolt, or lock so that the door may be selectively secure to the door frame, mullion, or underlying floor, as the present disclosure is not so limited.

FIG. 18 is a top schematic of one embodiment of an exit device 600 securing a door 602 for use under high loading conditions. As shown in FIG. 18, the exit device includes a push bar 604 configured to be depressed to retract the latch 620. The latch 602 of FIG. 18 is configured as a hook latch (see FIG. 19), although any suitable latch may be employed. According to the state shown in FIG. 18, the hook latch is in the engaged position and projects into a pocket 612 formed in a door frame 610 adjacent the door. The door is configured to swing open in the direction shown by the dashed arrow (i.e., up relative to the page). When the hook latch is in the engaged position shown in FIG. 18, the hook latch engages an egress loading side 613 of the door pocket 612 to resist the opening the of the door. The push bar 604 may be operable under these high loading conditions to retract the hook latch. Without wishing to be bound by theory, the force of operation to depress the push bar and retract the hook latch is dependent on the high loading on the hook latch at the egress loading side 613 of the door pocket. That is, the high loading force is transmitted to the egress loading side of the door pocket via the hook latch, and this contact force generates a resultant frictional force on the hook latch when the hook latch is moved toward the disengaged (i.e., retracted) position. Accordingly, this added friction increases the force to operate the push bar and retract the hook latch. As noted previously, this added force may increase the force of operation of the push bar which may be undesirable for emergency scenarios.

FIG. 19 is a front schematic of the exit device 600 of FIG. 18 with the hook latch 620 shown isolated for clarity. According to the view shown in FIG. 19, the door 602 opens out relative to the page. As shown in FIG. 19, the hook latch is in the engaged (i.e., extended) position and projects into the pocket 612 of the door frame 610. In particular, a hook end 622 of the hook latch projects through a strike plate 614 which forms an opening to the pocket. Accordingly, the hook latch prevents the door from opening. According to the embodiment shown in FIG. 19, the hook latch includes a tail end 624 which is mounted in the door 602. The hook latch is configured to rotated about the tail end (e.g., about a pin) between the engaged and disengaged positions (for example, see FIGS. 8-9). Accordingly, the hook latch is operable via the push bar (see FIG. 18) to move between engaged and retracted positions.

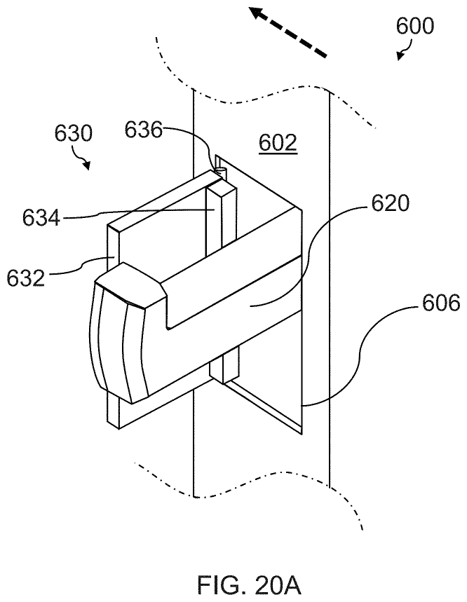

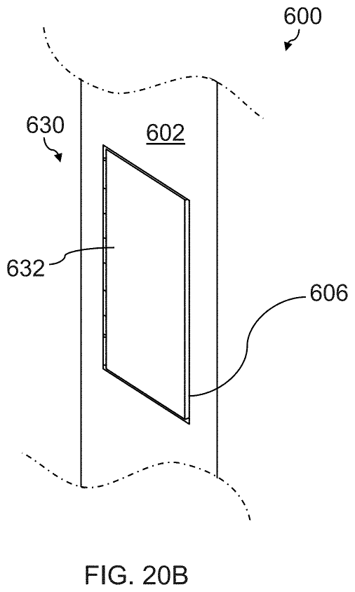

FIG. 20A is a perspective view of one embodiment of a hook latch 620 and a load blocker 630. According to the embodiment of FIG. 20A, the load blocker is configured to reduce a resultant frictional force during retraction of the hook latch when a door 602 is place under high loading conditions (e.g., in a direction of egress). In particular, the load blocker is configured to reduce a resultant torque on the hook latch as it is rotated between an engaged position shown in FIG. 20A and a disengaged position in which the hook latch is disposed in a latch opening 606 to reduce the operational force of an exit device when the door is loaded. As shown in FIG. 20A, the load blocker 630 includes a plate 632, an engagement beam 634, and a hinge 636. The plate 632 is sized and shaped to correspond to the size of the latch opening 606 formed in the door 602 so that the plate may be rotated about hinge 636 to be flush with the latch opening or project from the latch opening as shown in FIG. 20A. According to the embodiment of FIG. 20A, the hinge is arranged so that the plate 632 rotates about a longitudinal axis (i.e., vertical axis) of the door. Of course, the latch opening 606 may also be formed in a mortise lock or other suitable structure to allow the hook latch to extend from the door and retract into the door.

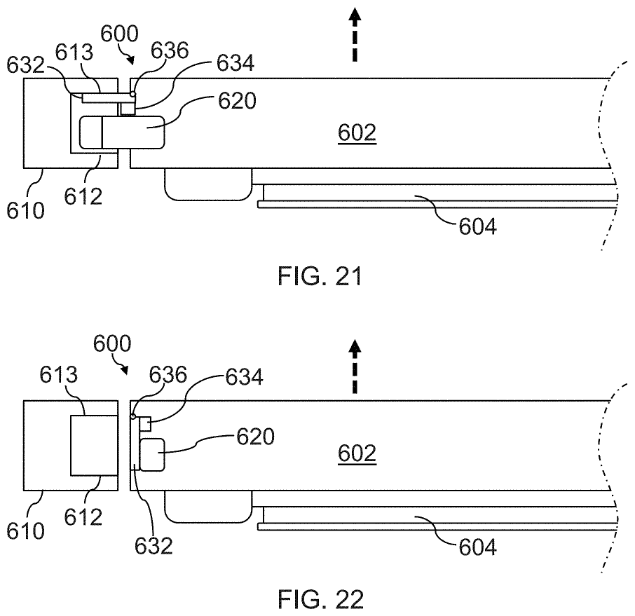

According to the embodiment of FIG. 20A, the engagement beam 634 is configured to transfer force between the plate 632 and the hook latch 620. That is, the engagement beam 634 is shaped and sized such that the engagement beam spans a gap between the hook latch and the plate so that force may be transferred therebetween. Accordingly, when a high load is applied to the door 602 (e.g., in a direction of egress or door opening shown by the dashed arrow), the plate 632 of the load blocker is configured to contact a door strike plate or pocket to resist the force. This force is resisted through the transmission of the force through the engagement beam to the hook latch, which prevents rotation of the plate about the hinge towards the latch opening 606. As noted previously, the hook latch 620 may be configured to rotate between the engaged position and the disengaged position. Accordingly, by transmitting high loading force to the hook latch via the engagement beam, any frictional force generated is applied closer to the pivot point of the hook latch that would be the case if the hook latch directly engaged a door strike plate or pocket. Additionally, in some embodiments, the smaller contact patch between the hook latch and the engagement beam may reduce a coefficient of friction of the hook latch relative to a hook latch engaging the pocket or a strike plate. Accordingly, the resultant frictional torque from the engagement beam 634 resisting the rotation of the hook latch towards the disengaged position is less than a resultant frictional torque from the hook latch directly engaging the door strike plate or pocket. Thus, the operational force for retracting the hook latch under high loading conditions may be reduced, as will be discussed further with reference to FIGS. 21-24.

In some embodiments, the engagement beam 634 may be shaped or composed of a low friction material suitable to reduce the coefficient of friction between the engagement beam and the hook latch. For example, the engagement beam may be composed of polyoxymethylene, acetal, polyacetal, polyformaldehyde, or nylon material. Additionally, the engagement beam may be shaped to reduce irregularities or sharp edges in the contact patch between the engagement beam and the hook latch. For example, the beam may be formed as a cylinder. Of course, the engagement beam may have any suitable shape, as the present disclosure is not so limited.

FIG. 20B depicts the hook latch and blocker 630 of FIG. 20A in a blocker disengaged position. As shown in FIG. 20B, the plate 632 of the blocker has been rotated to be flush with the latch opening 606 formed in the door. The plate substantially covers the latch opening so that the hook latch and other components disposed therein are covered. Such an arrangement may inhibit vandalism such as stuffing the latch opening with various materials. Additionally, such an arrangement may inhibit general dirt and grime buildup inside the latch opening. Of course, the plate 632 and the latch opening 606 may have any desirable shape and arrangement, as the present disclosure is not so limited.

FIGS. 21-22 are top schematics of the hook latch 620 and blocker 630 of FIG. 20A in a secure position and an unsecure position, respectively. As shown in FIG. 21, the hook latch 620 in in an engaged position, projecting into a pocket 612 of the door frame 610. Similarly, the plate 632 of the blocking member 632 also extends into the pocket, and is adjacent a portion 613 of the pocket which the plate contacts to resist an opening motion of the door in the direction shown by the dashed arrow (i.e., up relative to the page). As noted previously the plate includes a hinge 636 about which the plate rotates between a blocker engaged position shown in FIG. 21 and a blocker disengaged position shown in FIG. 22. The blocker also includes an engagement beam 634 which spans a gap between the plate 632 and the hook latch 620 which prevents the rotation of the plate about the hinge towards the blocker disengaged position. That is, the engagement beam contacts the hook latch 620 when a high load is applied to the door in the direction of egress to prevent rotation of the plate and the opening of the door 602. Accordingly, when a high load is applied to the door 602 the opening of the door is resisted by the hook latch indirectly through engagement beam 634 and plate 632. In contrast, when an external load is place on the door (e.g., from wind pressure, airborne objects, or attempts at forcing the door) the hook latch engages the pocket 612 of the door frame direction to resist the force. In some embodiments, the door frame may also include stop molding which also resists force applied externally.

FIG. 22 shows the hook bolt in a disengaged position and the blocker in a blocker disengaged position so that the door 602 may be opened. From the state shown in FIG. 21, the plate 632 of the blocker has rotated about the hinge 636 towards the door (i.e., counterclockwise relative to the page) until the plate is flush with the door or otherwise clears the door frame 610. According to the embodiment of FIGS. 21-22, the blocker may move automatically to the blocker disengaged positioned under a high load. That is, as the hook latch keeps the plate in the engaged (i.e., extended) position shown in FIG. 21, retraction of the hook latch may allow the contact force at the door pocket to rotate the plate 632 about the hinge towards the blocker disengaged position. In some embodiments, the load blocker 630 may include a biasing member (e.g., compression spring, extension spring, torsion spring which urges the blocker to the blocker disengaged position. In other embodiments, the blocker may include a retraction projection configured to contact the hook latch as the hook latch is moved to the disengaged (i.e., retracted) position. In this embodiment, the contact between the retraction projection and the hook latch may move the blocker to the blocker disengaged position. According to the embodiment of FIGS. 21-22, when the blocker is in the blocker disengaged position, the plate 632 may substantially cover a latch opening through which the hook latch extends and retracts. Accordingly, the blocker may be moved to the blocker engaged position by the hook latch when the latch is moved to the engaged position. That is, the hook latch may contact the plate 632 to push the plate open as the latch extends to engage the pocket 612 of the door frame. Thus, no actuator distinct from that used to extend or retract the hook latch is needed to move the blocker between the blocker engaged position and the blocker disengaged position.

As noted previously, according to the embodiment of FIGS. 21-22, when the blocker 630 is in the blocker disengaged position, the plate 632 may substantially cover a latch opening through which the hook latch extends and retracts (see FIG. 20B). Such an arrangement may be beneficial to inhibit vandalism of the latching device when the door 602 is open. That is, keeping the latch opening closed when the blocker is the blocker disengaged position may inhibit items being jammed or stuffed into the latching device, or from dirt or other material entering the latch opening. Such an arrangement may improve reliability of the latching device over period of long-term installation.

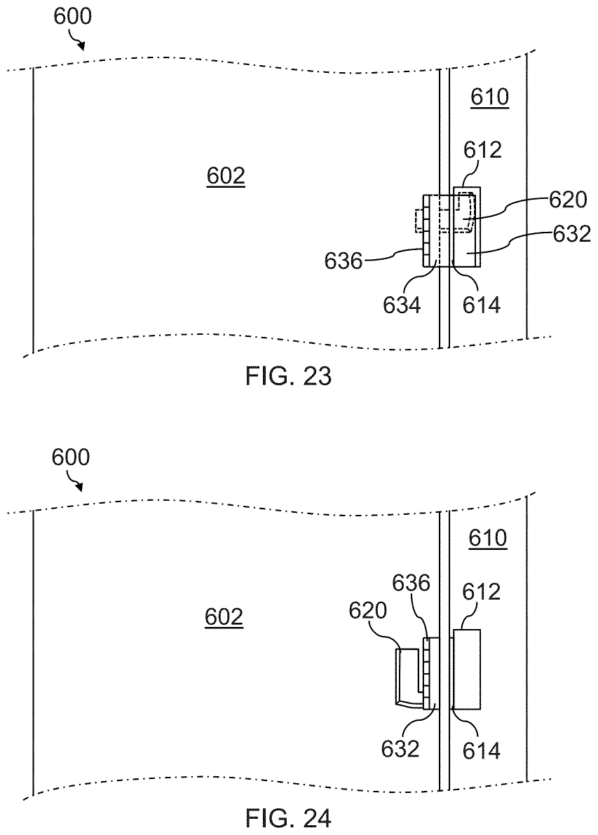

FIGS. 23-24 are front schematics of the hook latch 620 and blocker 630 of FIG. 20A in the secure position and the unsecure position, respectively. As shown in FIG. 23, the hook latch is disposed in the pocket 612 formed in the door frame 610 through a door strike plate 614 to secure the door 602 from being opened. Similarly, the plate 632 of the blocker is also disposed in the pocket 612 through the strike plate 614 and is configured to contact the pocket with a high load is applied to the door. The engagement beam 634 transfers the load on the plate to the hook latch and prevents the rotation of the plate to the blocker disengaged position shown in FIG. 23. As shown in FIG. 24, the blocker has rotated about hinge 636 to the blocker disengaged position where the plate 632 is not disposed in the pocket 612 of the door. In particular, the plate 632 is aligned and flushed with the door so that the blocker does not inference with movement of the door. Similarly, the hook latch is in a disengaged position and has been rotated approximately 90 degrees from the engaged position so that no portion of the hook latch projects from the door. Accordingly, the door may be opened under a high load in the state shown in FIG. 24.

According to the embodiment shown in FIG. 23-24 and as discussed previously, the combination of the blocker 630 and the hook latch 620 may reduce the operational force used to move the hook latch from the engaged position to the disengaged position when the door 602 is under a high load. As shown in FIG. 23, the plate 632 and engagement beam 634 transfer the load between the hook latch and pocket to a portion of the hook latch which is nearer its axis of rotation. Accordingly, a resultant frictional torque induced by rotating the hook latch to the disengaged position may be reduced relative to a resultant frictional torque on a hook latch without a blocker as a result of the reduction in moment arm. That is, without the blocker 630, the hook latch may contact the strike plate 614 or another portion of the pocket 612 which is a further distance from the axis of rotation of the hook latch than the contact patch between the engagement beam and the hook latch. Thus, the operational force for retracting the hook latch may be lowered by the blocker and engagement beam.

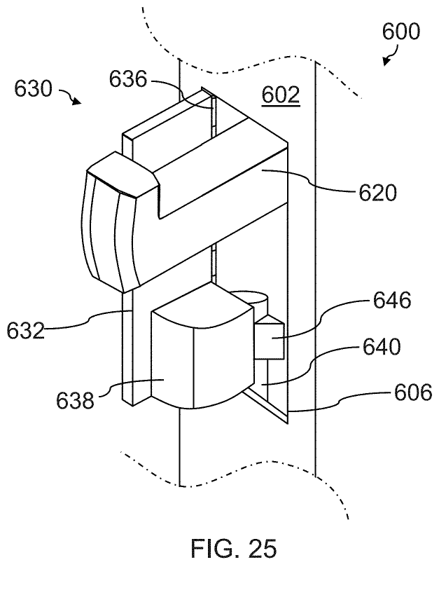

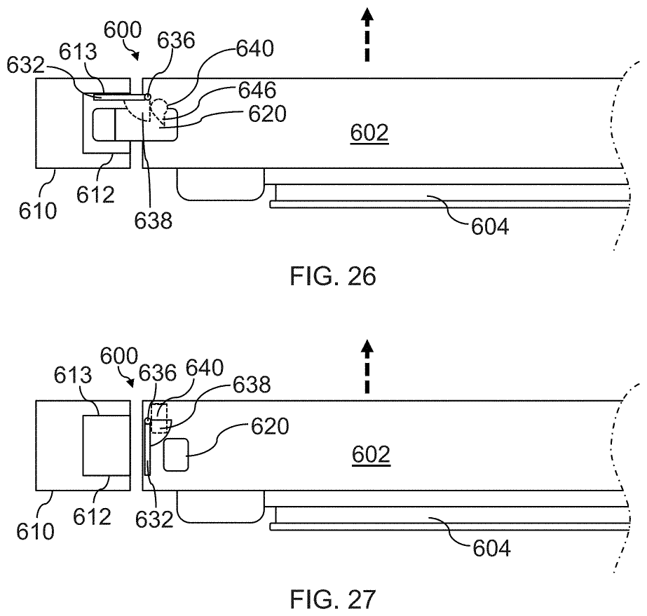

FIG. 25 is a perspective view of another embodiment of a hook latch 620 and a blocker 630 of a latching device which decouples high loading from the hook latch under normal operating conditions. Similarly to the embodiment of FIGS. 20A-24, the blocker and hook latch are disposed in a latch opening 606 formed in a door 602. The blocker includes a plate 632, and a hinge 636 about which the plate rotates between a blocker engaged position (shown in FIG. 25) and a blocker disengaged position where the plate is flush with the latch opening 606. In contrast to the embodiment of FIGS. 20A-24, the blocker also includes a wedge 638 and a bar 640 which are configured to receive a high load applied to the door, thereby preventing the high load from being transmitted to the hook latch. That is, the blocker transfers the high load applied to the door 602 to an associated door strike or pocket while the hook latch remains unloaded. According to the embodiment of FIG. 25, control of the hook latch may move the bar 640 to selectively secure the rotation of the blocker so that no additional actuators or linkages between a latching device and a latching location are employed. That is, the bar 640 includes a camming surface 646 configured to engage the hook latch when the hook latch is moved to the disengaged position, as will be discussed further below with reference to FIGS. 26-29. Of course, in other embodiments, the bar 640 may be controlled by an actuator of a latching device and any suitable linkage, as the present disclosure is not so limited.

FIGS. 26-27 are top schematics of the hook latch 620 and blocker 630 of FIG. 25 in a secure position and an unsecure position, respectively. As shown in FIG. 26, the plate 632 of the blocker is disposed in a pocket 612 formed in a door frame 610. The plate is adjacent a portion 613 of the pocket which contacts the plate to resist motion of the door under a high load (i.e., an egress load in the direction indicated by the dashed arrow). Additionally, the hook latch 620 is disposed in the pocket 612 and is configured to secure the door against external loads (e.g., wind pressure, airborne debris, etc.). As shown in FIG. 26, the wedge 638 is disposed between the plate 632 and the bar 640. In the state shown, the bar 640 is configured to contact the wedge to prevent rotation of the blocker about the hinge 636 to the blocker disengaged position. When a high load is applied to the door, force is transmitted through the bar, wedge, and plate to the door frame, thereby bypassing force transmission though the hook latch. Accordingly, the hook latch 620 may not contact any portion of the door frame when the door is high loaded and therefore no resultant frictional force or torque will be generated. Correspondingly, the operational force of the hook latch may be kept low even during high load situations.

As shown in FIG. 27, the plate 632 and wedge 638 have rotated about the hinge 636 to the blocker disengaged position. That is, the plate 632 is flushed with the door 602 so that the blocker clears the door frame. Similarly, the hook latch 620 is disposed in the door 602 in a disengaged position. As shown in FIG. 27, the bar 640 has been cammed to a rotational position 90 degrees offset from the position shown in FIG. 26. That is, the bar has been rotated about an axis parallel to a transverse axis of the door (i.e., left and right of the page) through rotation of the hook latch 620 to the disengaged position. Accordingly, when a push bar 604 is depressed in the state shown in FIG. 26, the hook latch is rotated toward a retracted or disengaged position while the blocker maintains the door in a secured position, resisting any high load. As the hook latch approaches the disengaged position, the hook latch contacts and cams the bar 640 along a camming surface 646 to the second rotational position, in which the bar no longer contacts the wedge 638 to resist rotation of the blocker to the blocker disengaged position. That is, the hook latch contacts and pushes the bar out of the way of the wedge as the hook latch is moved toward the disengaged position. As a result, the force from the high load bearing on the plate and/or force from a biasing member moves the blocker to the blocker disengaged position shown in FIG. 27. Thus, this sequential retraction of the hook latch and blocker allows the door 602 to be opened once both are in their respective disengaged positions shown in FIG. 27. Any added force on the hook latch during a retraction from a high load is merely the force applied to cam the bar out of the way of the wedge 638, which allows the operational force used to retract the hook latch to remain low even for large high loads. Of course, while a camming surface formed on the bar is shown in FIGS. 25-29, the camming surface may instead be formed on the hook latch, as the present disclosure is not so limited.

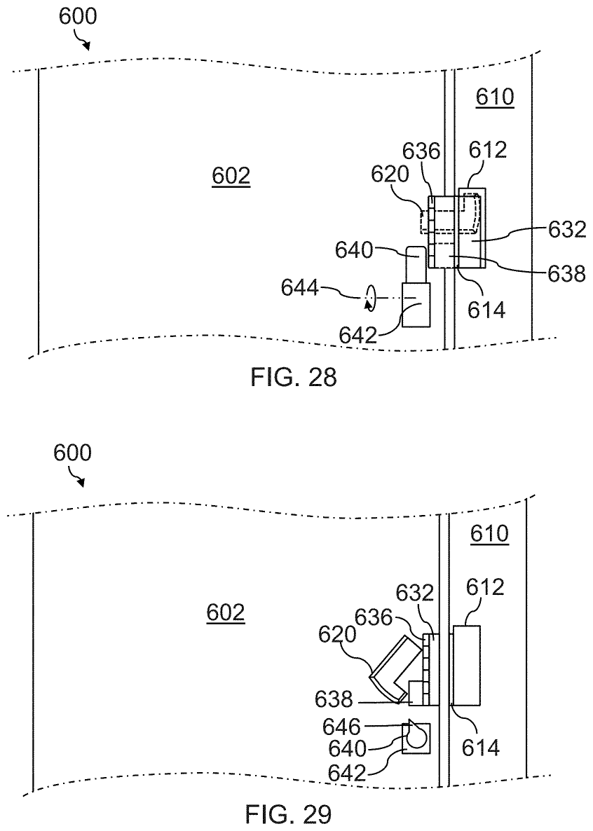

FIGS. 28-29 are front schematics of the hook latch 620 and blocker 630 of FIG. 25 in the secure position and the unsecure position, respectively. As noted previously and as shown in FIG. 28, in the secure position the hook latch 620 and the blocker 630 extend into the pocket 612 of the door frame 610 to secure the door against high loads and/or external loads. In particular, the hook latch 620 and plate 632 extend through a door strike 614 which forms an opening to the pocket. The wedge 638 is positioned on the plate and is configured to transfer force between the plate 632 and the bar 640 when the blocker is in the blocker engaged position shown in FIG. 28. As shown in FIGS. 28-29, the bar 640 is supported by a bar holder 642 which is configured to rotate about bar axis 644, but is constrained in other direction of rotation. Accordingly, the blocker engaged position, the bar receives force from the wedge in a direction approximately parallel to the bar axis which is resisted by the bar holder 644. However, when the hook latch retracts to the disengaged position shown in FIG. 29, the hook latch may cam the bar along camming surface 646 to rotate the bar and bar holder about the bar axis 644 out of the path of the wedge 638, as shown in FIG. 29.

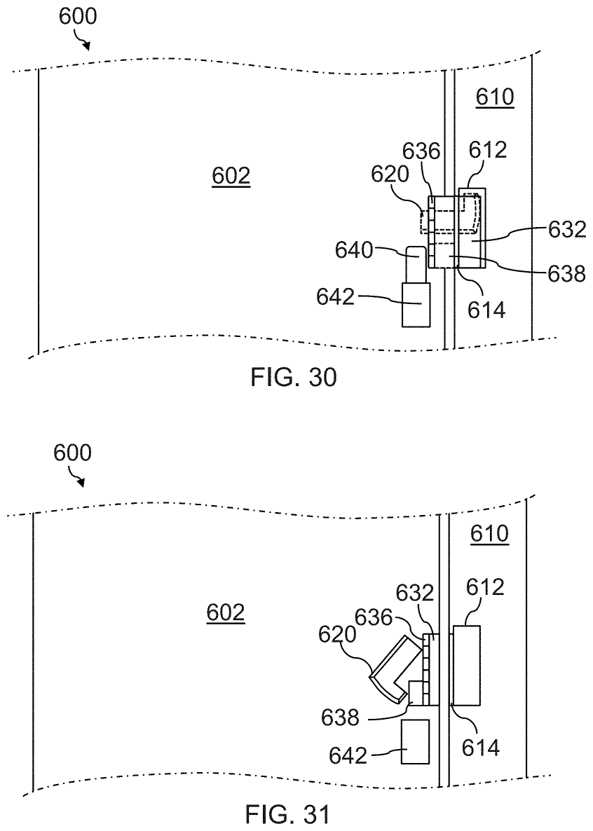

In the state shown in FIG. 29, the hook latch 620 and the blocker 630 are each in their respective disengaged positions. That is the hook latch 620 is disposed entirely within the door 602 and the plate 632 is flushed with the door, and may substantially cover a latch opening formed in the door. Correspondingly, the wedge 638 has also been rotated into the door about hinge 636. The bar 640 has been cammed about a bar axis so that the bar is no longer in the path of the wedge, which allowed the blocker to move to the blocker disengaged position relative to the state shown in FIG. 28. Accordingly, retraction of the hook latch may also allow the blocker to be moved to the blocker disengaged position under force of the high load or a biasing member which may be included to bias the blocker to the blocker disengaged position. This blocker biasing member may also keep the plate 632 flushed with the door when the door is moved when opened, and may further improve resiliency to vandalism as discussed previously. From the state shown in FIG. 29, extension of the hook latch may cause the hook latch to contact the wedge and/or plate 632 to force the block towards the blocker engaged position. That is, movement of the latch alone may be sufficient to move the blocker to the blocker engaged position. Similarly, movement of the hook latch may cam the bar rotate the bar back to a position in which the bar prevents rotation of the blocker toward the blocker disengaged position. Alternatively, in some embodiments the bar and/or bar body may include a bar biasing member configured to urge the bar to the state shown in FIG. 28 where the bar resists motion of the blocker to the blocker disengaged position. In this embodiment, the hook latch may not contact the bar as the hook latch is extended, and the bar may move into position to secure the blocker once the wedge clears the space to be occupied by the bar. In other embodiments, the bar may be actuated by a separate linkage which may move the bar linearly or in any other suitable direction to selectively move the bar in and out of engagement with the wedge 638. For example, a linkage may move the bar 640 into the bar body 642 when an actuator of a latching device is operated to allow the blocking member to retract, as will be discussed further with reference to FIGS. 30-31.

FIGS. 30-31 depict another embodiment of a hook latch 620 of a latching device 600 and a blocker with a bar 640 which maintains the blocker in the blocker engaged position. Similarly to the embodiment of FIGS. 25-29, the blocker includes a plate 632 and a wedge 638 which are configured to rotate about a hinge through a strike plate 614 and into a door pocket 612 when the blocker is in the blocker engaged position shown in FIG. 30. As shown in FIG. 30, in the blocker engaged position the blocker is retained in position by the bar 640 contacting the wedge 638 and preventing rotation of the blocker toward the blocker disengaged position shown in FIG. 31 and thereby transferring a load on the door 602 away from the hook latch 620. According to the depicted embodiment and in contrast to the embodiment of FIGS. 25-29, the bar is configured to retract and extend from a bar holder 642. That is, the bar linearly reciprocates between a bar extended position shown in FIG. 30, and a bar retracted position shown in FIG. 31. As shown in FIG. 31, when the bar is retracted the bar no longer interferes with the wedge 638 and the blocker is able to be rotated to the blocker disengaged position under force of a load applied to the door in a direction of egress or under force of a biasing member. The bar may be coupled to an actuator of the latching device (e.g., a push bar, handle, etc.) and may be moved to the bar retracted position when the actuator is operated with an operational force.

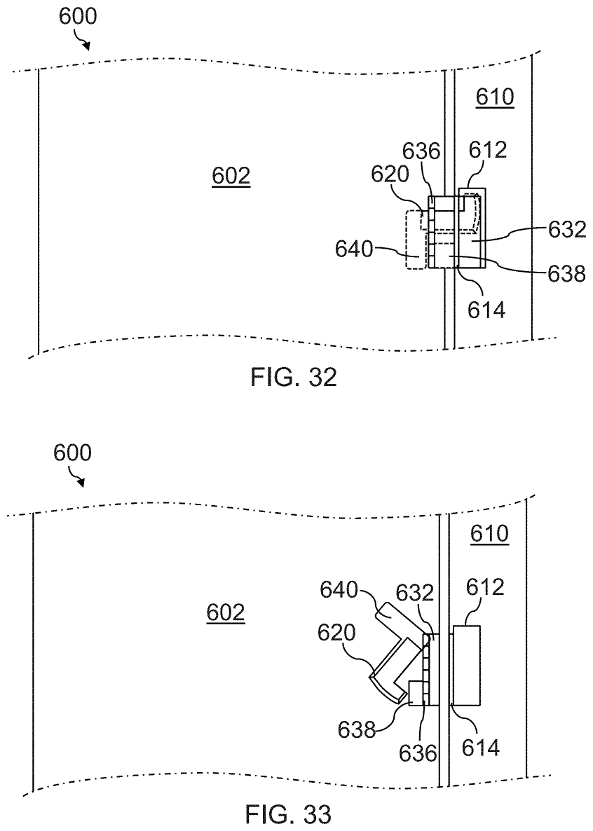

FIGS. 32-33 depict another embodiment of a hook latch 620 of a latching device 600 and a blocker with a bar 640 which maintains the blocker in the blocker engaged position. Similarly to the embodiment of FIGS. 25-29, the blocker includes a plate 632 and a wedge 638 which are configured to rotate about a hinge through a strike plate 614 and into a door pocket 612 when the blocker is in the blocker engaged position shown in FIG. 32. As shown in FIG. 32, in the blocker engaged position, the blocker is retained in position by the bar 640 contacting the wedge 638 and preventing rotation of the blocker toward the blocker disengaged position shown in FIG. 33. In contrast to prior embodiments, the bar 640 of FIGS. 32-33 is coupled to or formed with the hook latch 620 and rotates concurrently with the hook latch as the hook latch moves between an engaged position (see FIG. 32) and a disengaged position (see FIG. 33). Accordingly, when a load is applied to the door 602, the blocker resists the force by the plate 632 contacting the door pocket 612 or strike plate 614 and the load is transferred to the bar via the wedge 638. The load may be transferred to the hook latch in a direction towards a pin about which the hook latch rotates. The pin of the hook latch may resist the force as may various transmission elements which may couple the hook latch to an actuator of the latching device, such as a vertical rod. According to the embodiment of FIGS. 32-33, the force received by the bar by the blocker may urge the hook latch toward the disengaged position. A sear, trigger, or other arrangement of the latching device may then be used by an operator to retract the hook latch using a force applied to the door 602 in a direction of egress. Thus, the arrangement shown in FIGS. 32-33 may decrease or otherwise reduce the operational force of a door when the door is under a high load in a direction of egress.

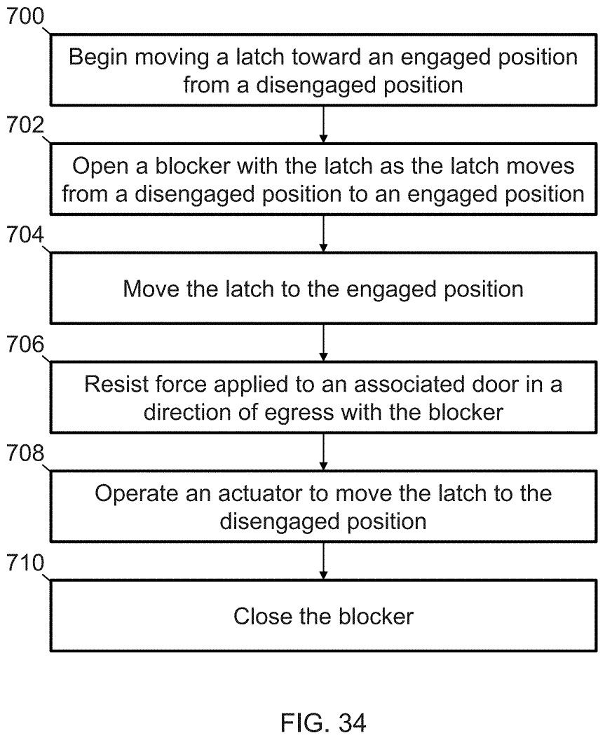

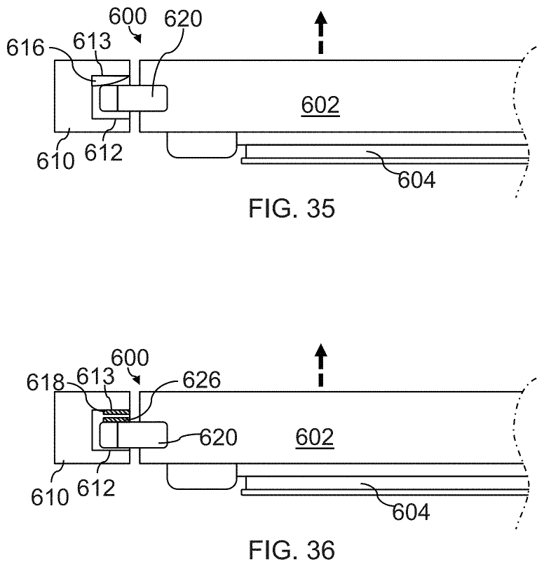

FIG. 34 is a block diagram for one embodiment of a method for operating a latching device having a blocker according to exemplary embodiments described herein. At block 700, a latch begins moving toward an engaged position from a disengaged position. For example, a hook latch may be moved from a first rotational position toward a second rotational position to begin extending the hook latch from the door. As another example, a latch may be linearly moved from a first linear position to a second linear position. At block 702, a blocker is opened with the latch as the latch moves toward the engaged position. For example, the blocker may include a plate which substantially covers a latch opening which may be contacted by the latch. Opening the blocker may include rotating the blocker about a hinge, or may include moving a blocker linearly (for example, see FIG. 35). At block 704, the latch is moved to the engaged position. In the engaged position, the latch may secure the associated door from external loads place on the door (e.g., wind pressure, airborne debris, etc.). At block 706, the blocker resists force applied to an associated door in a direction of egress (i.e. a direction in which the door opens) with the blocker. For example, the blocker may transfer the load to the latch at a mechanically advantaged portion (e.g., by reducing a moment arm for resultant frictional forces on a latch) or may resist the force directly (e.g., with a bar). At block 708 an actuator is operated to move the latch to the disengaged position. For example, the actuator may be a push bar of an exit device, or may be a handle or lever. At block 710 the blocker may be closed. Closing the blocker may include moving the blocker into the associated door or flushed with the associated door. In some embodiments, the steps in blocks 708 and 710 may happen concurrently.

FIG. 35 is a top schematic of yet another embodiment of a latching device 600 having a latch 620 securing a door 602. As shown in FIG. 35, the latching device does not include a blocker, but includes a curved high load face 616 configured as a convex surface arranged along a portion 613 of a pocket 612 which resists a high egress load applied to the door. Without wishing to be bound by theory, the curved high load face may reduce sharp contact patches, thereby reducing the coefficient of friction between the door frame and the latch. Additionally, the curved face may convert from of the high load contact forces into a normal force directing the latch toward a retracted or disengaged position. This normal force may assist an operator in using an actuator to open the door. Thus, the curved high load face may be employed to reduce the coefficient of friction and/or generate normal forces which reduce the retraction force of the latch under high loads. The embodiment of FIG. 35 may be employed in combination with other embodiments described herein to further reduce the operational force for retracting the latch 620 under a high load.

FIG. 36 is a top schematic of yet another embodiment of latching device 600 having a latch 620 securing a door 602. As shown in FIG. 36, the latching device does not include a blocker, but includes allow friction material 618 arranged along a portion 613 of a pocket 612 which resists a high load applied to the door. Without wishing to be bound by theory, the low friction material may reduce the coefficient of friction between the door frame and the latch. Additionally, as shown in FIG. 36 the latch 620 includes a low friction latch material 626 configured to contact the low friction material 618 disposed in the pocket 613. The low friction material and low friction latch material may be formed of polyoxymethylene (or another acetal, polyacetal, or polyformaldehyde), nylon, or any other suitable material, as the present disclosure is not so limited. Thus, the low friction materials may be employed to reduce the coefficient which reduces the retraction force of the latch under high loads. The embodiment of FIG. 36 may be employed in combination with other embodiments described herein to further reduce the operational force for retracting the latch 620 under a high load.

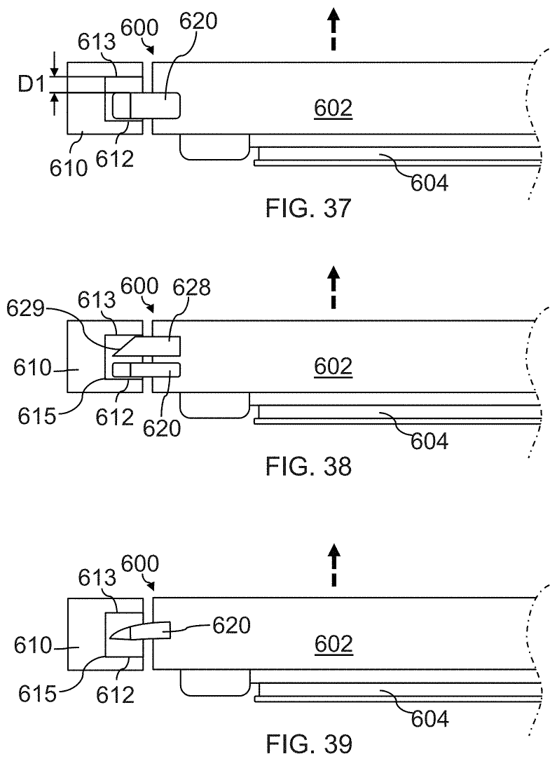

FIG. 37 is a top schematic of yet another embodiment of a latching device 600 including a latch 620 securing a door 602. As shown in FIG. 37, the latching device does not include a blocker, but instead the latch 620 is offset relative to a center of a pocket 612 of a door frame 610 and/or door 602. More specifically, the latch 620 is spaced a first distance D1 from a portion 613 of the pocket 612 which resists force when the door is placed under high loading as shown by the dashed arrow. According to the embodiment of FIG. 37, such a latch arrangement may be employed in combination with one or more other latches which are not spaces from their respective pockets. When the latch of FIG. 37 is employed with other non-offset latches, before the latch 620 engages the pocket of the door frame, the door may move or deflect in the direction of opening. That is, the other non-offset latches may resist the load applied to the door, and the latch 620 may only contact the portion 613 of the pocket 612 when the door deflects or moves to eliminate the first distance D1. Accordingly, the gap may prevent or otherwise reduce contact between the latch 620 and the door pocket 612 when used in combination with one or more other non-offset latches, thereby reducing the resultant frictional forces when the latch 620 is moved to a disengaged position. Such an arrangement may be particular beneficial for hook latches which rotate between engaged positions and disengaged positions, as this rotation may generate significant frictional forces under a high load. The embodiment of FIG. 36 may be employed in combination with other embodiments described herein to further reduce the operational force for retracting the latch 620 under a high load.

FIG. 38 is a top schematic of yet another embodiment of a latching device 600 having a latch 620 securing a door 600. According to the embodiment of FIG. 38, the latching device also includes a second latch 628 which is adjacent to the latch 620 and extends into the same pocket 612. The second latch 628 is disposed adjacent a first portion 613 of the pocket 612 which resists forces applied to door under high loading, while the latch 620 is positioned adjacent a second portion 615 which resists external forces applied to the door. Accordingly, when the door is undergoing high loading, the second latch 628 secures the door, while under external loading the latch 620 may secure the door. According to the embodiment of FIG. 38, the latch 620 may be a hook latch which rotates between engaged and disengaged positions, whereas the second latch 628 is configured as a latch bolt which moves linearly between the engaged and disengaged positions. The latch 620 and the second latch 628 may be coupled to one another to move between the engaged and disengaged positions concurrently. Without wishing to be bound by theory, the resultant frictional forces generated by a hook latch which increase an operational force of a latching device under load may be greater than those generated by a latch bolt under load because of the different in retraction motion (i.e., rotational motion versus linear motion). For example, the mechanical advantage of a frictional force working with a moment arm on a rotating latch may increase the operational force of a door more so than frictional force on a reciprocating latch. Accordingly, the arrangement of FIG. 38 may reduce the operational force to retract the latch 620 and the second latch 628 when the door is under high loading. As shown in FIG. 34, the second latch 628 also includes an inclined face 629 which is configured to convert some of the contact forces between the second latch and the pocket into normal forces which assist the retraction of the second latch. That is, as the second latch begins retracting, the inclined face may contact the pocket and this contact may urge the second latch toward a disengaged position. Such an arrangement may further reduce the operational force to retract the latch 620 and the second latch 628. The embodiment of FIG. 38 may be employed in combination with other embodiments described herein to further reduce the operational force for retracting the latch 620 under a high load.

FIG. 39 is a top schematic of yet another embodiment of a latching device 600 having a latch 620 securing a door 600. According to the embodiment of FIG. 39, the latch 620 is a hook latch which rotates between a latch engaged position and a latch disengaged position and is sized and shaped to reduce resultant friction when the latch is moved to the latch disengaged position and an associated door is loaded in a direction of egress. As shown in FIG. 39, the hook latch is curved or tapered to reduce the side of a contact patch between the hook latch and a strike or pocket 612 formed in a door frame 610. That is, the hook latch has a convex surface configured to engage an associated door pocket 612 or door strike. Such an arrangement may reduce the coefficient of friction between the hook latch and the strike or door pocket. In some embodiments, the hook latch may rotate on a bearing about an axis of rotation of the hook latch. Such an arrangement may reduce the resultant friction generated when the hook latch is rotated to the latch disengaged position. The embodiment of FIG. 39 may be employed in combination with other embodiments described herein to further reduce the operational force for retracting the latch 620 under a high load.

It should be understood that a latching device such as an exit device latch may include any suitable number and type of latches in any suitable location which may employ blockers to reduce operational force under high loading of a door. For example, in some embodiments, an exit device operable with a push bar may operate a single latch at a center portion of a door. In other embodiments, an exit device may be operate multiple latches which are coupled with one or more vertical rods, such as transom latches, bottom latches, or side latches disposed away from a central portion of a door. Additionally hook latches, deadbolts, or latch bolts may be employed in any of these latching locations. Accordingly, it is contemplated that exemplary embodiments of blockers described herein with reference to FIGS. 20A-34 may be applied to any latching device having a latch, as the present disclosure is not so limited.

In some embodiments, door secured with latching devices according to exemplary embodiments described herein may be suitable for use with exit devices in high loading situations. For example a latching device may be cycle tested to at least 500,000 cycles, and, in some embodiments, at least 1,000,000 cycles. During this cycle testing, the watching device may be preloaded with a weight. In some embodiments, while the door is latched, a force of 20 to 22 lbf (˜80 to 98 N) is applied in the direction of the door swing, 3 inches from a latch edge and 40 inches from the floor. After the preload force is applied, the hardware is then actuated, the door opens, closes, and latches, completing the cycle. Of course, in other embodiments, greater preload may be applied to the door or any other suitable preload for cycle testing. In some embodiments, the door may be tested to a high load of at least 250 lbs (˜1100 N) in a direction of egress. Under this load, the latching device may be operable with a force of under 50 lbs (˜220 N) to retract one or more latches retaining the door against the 400 lbs high load. In a loaded or unloaded condition, latching devices of exemplary embodiments herein may be operable with a force of under 15 lbs (˜66 N), 5 lbs (˜22 N), and or any other suitable operational force. The high load testing may be performed before and after cycle testing as described above, except the latching device may be tested to at least 100,000 cycles before a second high load test. Of course, doors secured by the latching devices of embodiments described herein may meet any suitable standards for use in high occupancy areas, including, but not limited to UL 305, ANSI/BHMA A156.3, NFPA 101, IBC, and/or any other modern or updated testing standard, as the present disclosure is not so limited.

In some embodiments, doors secured with latching devices according to exemplary embodiments described herein may be suitable for use in high wind areas. For example, a door secured by the latching device of FIG. 1 may withstand a first impact from a 6.8 kg 2×4 piece of lumber traveling at a speed between 80 mph and 100 mph near the transom latch. The same secured door may then subsequently withstand a subsequent second impact from a 6.8 kg 2×4 piece of lumber traveling at a speed between 80 mph and 100 mph near the actuator. Finally, the same secured door may subsequently withstand a subsequent third impact from 6.8 kg 2×4 piece of lumber traveling at a speed between 80 mph and 100 mph near a hinge interface of the door. In cases where a pair of doors is employed and at least one is secured with a latching device according to exemplary embodiments disclosed herein, the secured door may withstand a subsequent fourth impact from a 6.8 kg 2×4 piece of lumber traveling at a speed between 80 mph and 100 mph near a mullion interface between the two doors. Additionally, a door secured by an latching device of exemplary embodiments described herein may withstand positive or negative pressure as a result of wind speeds between 130 and 250 mph. Withstanding the above noted impacts or pressures may be determined at least partially by measuring perforation of a witness screen placed proximate the door. That is, a door withstands impact or pressure when a #70 unbleached kraft paper witness screen with its surface secured in place on a rigid frame installed within 5 inches of the interior surface of the door remains unperforated after the impact or pressure. Furthermore, a door may withstand impact or pressure when permanent deformation of the door measured from a straight edge held between two undeformed points on the door is less than or equal to 3 inches. Of course, doors secured by the latching devices of embodiments described herein may meet any suitable standards for use in high wind areas, storm shelters, etc., including, but not limited to ICC 500, FEMA P361, FEMA P320, or any other modern or updated testing standard, as the present disclosure is not so limited.

While the present teachings have been described in conjunction with various embodiments and examples, it is not intended that the present teachings be limited to such embodiments or examples. On the contrary, the present teachings encompass various alternatives, modifications, and equivalents, as will be appreciated by those of skill in the art. Accordingly, the foregoing description and drawings are by way of example only.

What is claimed is:

1. A latching device, comprising:
a first latch movable between a first latch engaged position and a first latch disengaged position, wherein in the first latch engaged position the first latch is configured to engage a pocket of an associated door frame; and
a blocker configured to move between a blocker engaged position and a blocker disengaged position, wherein the blocker is configured to engage the pocket when the blocker is in the blocker engaged position, and wherein the blocker is configured to resist a force applied to an associated door in a direction of egress.

2. The latching device of claim 1, wherein the first latch is a hook latch configured to rotate between the first latch engaged position and the first latch disengaged position.

3. The latching device of claim 1, wherein the blocker includes a plate configured to be disposed between the first latch and the pocket when the blocker is in the blocker engaged position.

4. The latching device of claim 3, wherein the plate is configured to cover a first latch opening form in the associated door when the blocker is in the blocker disengaged position.

5. The latching device of claim 3, wherein the blocker further includes a hinge, wherein the blocker is configured to rotate between the blocker disengaged position and the blocker engaged position about the hinge.

6. (canceled)

7. The latching device of claim 5, wherein the blocker further includes an engagement beam configured to transfer the force applied to the associated door in the direction of egress from the plate to the first latch.

8. The latching device of claim 5, wherein the blocker further includes a bar, wherein the bar is configured to receive the force applied to the associated door in the direction of egress from the plate, wherein the bar is configured to prevent rotation of the blocker about the hinge.

9. (canceled)

10. The latching device of claim 1, wherein the first latch is configured to move the blocker to the blocker engaged position when the first latch moves to the engaged position.

11. The latching device of claim 1, wherein the first latch is configured to move the blocker to the blocker disengaged position when the first latch moves to the disengaged position.

12. The latching device of claim 1, wherein the blocker is biased toward the blocker disengaged position.

13. The latching device of claim 1, further comprising an exit device including a push bar, wherein the push bar is configured to move the first latch from the first latch engaged position to the first latch disengaged position when the push bar is depressed.

14. The latching device of claim 1, further comprising a second latch configured to move between a second latch engaged position and a second latch disengaged position, wherein in the second latch engaged position the second latch is configured to engage a pocket of an associated door frame.

15. The latching device of claim 14, further comprising an exit device including a push bar, wherein the push bar is configured to move the first latch from the first latch engaged position to the first latch disengaged position and the second latch from the second latch engaged position to the second latch disengaged position when the push bar is depressed, and wherein the first latch is coupled to the push bar via a vertical rod.

16. The latching device of claim 15, wherein the first latch is a hook latch configured to rotate between the first latch engaged position and the first latch disengaged position.

17. The latching device of claim 16, wherein the push bar is operable with less than 50 lbs of force when the force applied to the door in the direction of egress is approximately 250 lbs.

18. The latching device of claim 17, wherein when the associated door is secured by the first latch in the first latch engaged position and the second latch in the second latch engaged position, the door withstands impact from a 6.8 kg 2×4 piece of lumber traveling at a speed between 80 mph and 100 mph.

19.-32. (canceled)

33. A latching device comprising:
a hook latch configured to rotate been a latch engaged position and a latch disengaged position, wherein the hook latch includes an engagement surface configured to engaged an associated strike plate of a door frame, and wherein the engagement surface is configured to reduce a frictional force between the hook latch the associated strike plate when the hook latch is moved to the latch disengaged position.

34. The latching device of claim 33, wherein the engagement surface is a convex surface.

35. (canceled)

36. (canceled)

37. The latching device of claim 33, further comprising the strike plate, wherein the strike plate includes a hook latch engagement surface configured to reduce a frictional force between the hook latch the associated strike plate when the hook latch is moved to the latch disengaged position.

38. The latching device of claim 37, wherein the hook latch engagement surface is a convex surface.

39. (canceled)

40. (canceled)
